(19) United States
(12) Patent Application Publication
(10) Pub. No.: US 2025/0031136 A1
(43) Pub. Date: Jan. 23, 2025

(54) DYNAMIC AD HOC NETWORK RANGE DETERMINATION

(71) Applicant: Micron Technology, Inc., Boise, ID (US)

(72) Inventor: Sujeet Ayyapureddi, Boise, ID (US)

(21) Appl. No.: 18/767,700

(22) Filed: Jul. 9, 2024

Related U.S. Application Data
(60) Provisional application No. 63/527,503, filed on Jul. 18, 2023.

(51) Int. Cl. H04W 48/16; G08G 1/0967; H04W 4/40; H04W 52/38; H04W 84/18

(52) U.S. Cl. CPC H04W 48/16; G08G 1/096791; H04W 52/383; H04W 4/40; H04W 84/18

(57) ABSTRACT

Systems and methods determining a range for seeking data sources for a dynamic ad hoc network of a vehicle are disclosed including receiving information about the vehicle, determining a range for seeking data sources of the dynamic ad hoc network for the vehicle based on the received information, receiving navigation or safety information from one or more other vehicles in the dynamic ad hoc network, and determining one or more control inputs to the vehicle based at least in part on the received navigation or safety information from one or more other vehicles in the dynamic ad hoc network.

PRIORITY APPLICATION

This application claims the benefit of priority to U.S. Provisional Application Ser. No. 63/527,503, filed Jul. 18, 2023, which is incorporated herein by reference in its entirety.

### BACKGROUND

Traffic congestion is a global problem. Modern routing and navigation solutions often require a data connection to a wireless network, often broadband cellular networks, such as a 5G network, etc. However, coverage and bandwidth, although improving, can be insufficient at times.

Additionally, as autonomous vehicle technology continues to advance through the use of different sensors and sensing modalities, the amount of computing performed by each vehicle continues to increase, requiring advanced processing capabilities. There is a growing need to ease traffic congestion, coverage and bandwidth limitations in wireless networks, as well as computing requirements in modern vehicles.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates an example system to process data associated with a first resource.

FIGS. 2-4 illustrate example diagrams of a first resource traveling along example roadways.

FIG. 5 illustrates an example map illustrating a route for a first resource.

FIG. 6 illustrates an example method.

FIG. 7 illustrates an example system including a host device and a storage device.

FIG. 8 illustrates a block diagram of an example machine upon which any one or more of the techniques discussed herein may perform.

### DETAILED DESCRIPTION

Many modern mapping systems currently employ static algorithms to optimized route guidance between two points on a map at the time of request. Optimized route guidance generally solves for a desired result, such as to provide a shortest time of travel for the user, to maximize freeway travel or fuel economy, to minimize toll ways or travel costs, etc.

The present inventors have recognized, among other things, advances to route guidance and autonomous vehicle control through novel control, formation, and data consideration of ad hoc networks in proximity to the autonomous vehicle or other computing resource (e.g., a mobile device, an edge computing resource, a computing device acting as an edge computing resource, etc.). The techniques presented herein can reduce congestion on traditional mobile networks, effectively increase wireless network coverage, as well as reduce the amount of processing or processing resources required by each autonomous vehicle, in certain examples making existing computing resources available to other users, improving general computing bandwidth, etc.

There are six levels of autonomous driving: zero through five, from automated warning systems (level zero) to full self-driving requiring no human intervention or control (level five). Autonomous driving requires a large amount of sensed and stored data from a number of sensors. Different technologies enable autonomous driving including GPS (global positioning system), cameras (e.g., thermal and imaging), radar, and LiDAR (light detection and ranging) each having different sensor costs and processing requirements. The most advanced autonomous vehicles use all three technologies in different capacities for vehicle control, routing, and safety considerations, with control systems that require frequent updates.

The present inventors have recognized that not all vehicle computing, sensing, or wireless connection to a cloud service must be done by each vehicle at each request. In perfect conditions, wireless connection to a cloud network would available and instantaneous and all sensors would be available for navigation and control and safety without limitation and with enough processing resources to utilize, not only each separately, but combined. However, conditions are not perfect. Wireless connection is limited by coverage and bandwidth. Sensors or sensing data can be limited by cost, field of vision, conditions, or other factors, and processing capabilities are limited.

In certain examples, such as at times of network constraints (e.g., when a large number of computing resources are vying for a limited data connection), it can be beneficial for the resources themselves to include one or more circuits to create ad hoc communication and data sharing networks, such as vehicle-to-vehicle (V2V) networks or smaller more local networks comprising vehicles and other computing resources (e.g., mobile phones, edge computing resources, etc.) through wireless connection technologies, including radio frequency or cellular connection technologies, such as Bluetooth®, Wi-Fi, near-field communication (NFC), low-power WAN (LPWAN), ultra-wideband (UWB), IEEE 802.15.4 (e.g., Zigbee, Z-Wave, Thread, etc.), etc., separate from and without connecting to a central cloud networking resource or data center. Existing V2V communication allows vehicles to broadcast and receive omni-directional messages including position, heading or direction of travel, and speed data, creating “awareness” of other vehicles.

In certain examples, the ad hoc network can be used for other purposes. For example, if an event is ending and many users are exiting an area and a first resource (e.g., a vehicle) has mapped a route based on current conditions to a destination through one or more intermediate destination points using a central cloud network, the information provided to the first resource, such as the destination or one or more intermediate destination points, can be distributed to one or more other resources discoverable and connected to the first resource through a radio frequency technology requesting a similar location or intermediate destination point, where the similarity can be determined using stored mapping information at the different resources.

In other examples, other information can be broadcast to discoverable or connected resources, such as situational or safety information (e.g., detection, determination, or classification of objects (or items) on roadways, heading or direction of travel, braking information, identification of possible objects off of a roadway, determination of road conditions, atmospheric conditions, etc.), convenience information (e.g., data or resource sharing), routing information (e.g., self-driving input, navigation instructions, etc.), etc. In addition to position (e.g., coordinates, etc.), heading, and speed data, broadcast information can include acceleration, braking input, number of passengers, delay time, time between cloud connections, data capabilities, or other vehicle information.

To retain data security, communications between resources can be obfuscated, with identifying information removed and replaced with random unique identifiers (e.g., a random 1K bit Unique Identifier) for each routing trip or portion of a routing trip. Communication between resource scan be encrypted for data privacy and security.

The range of radio frequency communication can be limited by the type of communication but also, in certain examples, the power radiated by a transmitter or amplified by a receiver. Different radio frequency technologies have different communication ranges. Typical ranges vary between one foot or less, several feet or meters, 10 feet, 10 meters, 20 meters, 100 feet, 100 meters, 240 meters, 1 km, 1 mile, or several miles or more depending on technology and power.

For example, the latest Bluetooth® versions (e.g., Bluetooth® 5.0, etc.), based on one or more communication settings, such as additional transmitter power, transmitter antenna gain, and receiver antenna gain, and receiver sensitivity, can have a communication range of 1 km or greater (e.g., up to nearly 2 km with particular combinations of receiver sensitivity (e.g., 125k coded PHY), receiver antenna gain (e.g., 10 dBi), transmitter power (e.g., 20 dBm), and transmitter antenna gain (e.g., 10 dBi), etc.). Receiver sensitivity can be selected at the physical layer in the receiver circuit, with range generally inversely proportionate to bandwidth (e.g., between 3M and 125k, etc.). The physical layer (PHY) can be identified by a preamble of a packet.

Other radio frequency technologies (e.g., UHF, broadband cellular communication (e.g., LTE, 4G, 5G, etc.), etc.) can have communication ranges up to several miles, with different power requirements for different ranges (e.g., generally more power required for longer range). For example, 5G range can include up to 1 to 3 miles, whereas 4G and LTE range can be up to 2 to 4 miles. Power consumption between the different communication types can vary between 1 mW and 100 mW or greater, up to several watts, depending on technology and desired communication range.

In certain examples, the power required by one or more components of a communication system (e.g., transmitter circuit, receiver circuit, antenna gain, etc.) can be adjusted, such as by a processor or other control circuit, based on a desired range of the ad hoc network. In addition, a number of data sources from which a first resource can receive and process information can be adjusted, such as to control the amount of power and processing resources associated with received data. Each of the desired range and the number of data sources can vary according to various factors including one or more of: (1) the number sources (e.g., vehicles or other resources) surrounding, available to, or already connected to the first resource; (2) a speed of the first resource; (3) awareness of a type of roadway of the first resource (e.g., identification of traffic signs, etc.); (4) a number of different or alternate pathways available to the first resource (e.g., interstate versus grid layout versus rural roadway, etc.); (5) the number of resources moving with the first resource versus against or perpendicular to the first resource; (6) road or visibility conditions; (7) conditions with respect to the individual sensors local to the first resource versus available to the one or more sources surrounding, available to, or connected to the first resource; (8) traffic density; (9) a type of barrier between lanes of traffic (e.g., divided highway versus physical barrier versus painted line separation, impacting safety, etc.); (10) the distance between the roadway and objects off of the roadway; (11) sensitive areas, such as playgrounds, parks, schools, crosswalks, pedestrian pathways, railroads, etc.; (12) detection of other type of traffic on or along the roadway (e.g., pedestrian traffic, bicycle traffic, construction, etc.); etc.

For example, at a higher rate of speed or on a roadway with less traffic, a larger range (e.g., greater than 100 meters, such as 1 km, etc.) can be provided to ensure communication by the first resource with a sufficient number of other sources (e.g., vehicles) for various operations, such as safety (e.g., detection of objects on roadways, direction of travel, braking information, identification of possible objects off of a roadway, etc.), convenience (e.g., data or resource sharing), routing (e.g., self-driving input, navigation instructions, etc.), etc. Processing requirements for safety increase for each resource with respect to speed. Receiving already-processed information from other resources can reduce the amount of processing required for each individual resource.

In certain examples, a curated set of connected sources can be maintained to satisfy a desired combination of sensors or information, prioritized for various conditions. For example, connection sources can be prioritized based on one or more of available sensors, available processing resources, available data resources, rate of speed or direction of travel, proximity of destination or shared intermediate destination points etc.

Sharing information with other resources is important. Although receiver resources can be prioritized in contrast to transmitter resources (as transmitter power and transmitter antenna gain of coupled resources are at the control of respective sources), parity between transmitter and receiver resources by the first resource can encourage reciprocity from other sources (e.g., connected sources, etc.).

For example, on a divided highway or when a first resource (e.g., a vehicle) is moving at a high rate of speed, a ratio of resources moving in the same direction versus resources available but moving at an opposite or perpendicular direction can be determined as a function of conditions or the speed of travel, with a preference for connecting to resources in front of the moving vehicle rather than behind (e.g., 5-to-1, 7-to-1, 9-to-1, etc.), such as for safety considerations. While connecting to trailing resources can be beneficial for certain convenience or navigation operations, safety considerations may prioritize resources having already determined or received safety information or traversed the intended path without issue. Closer resources are generally preferred to resources farther away, such as to increase a connection time of the connected sources or to reduce power requirements of one or more components of a communication circuit.

However, there can be value in connecting to resources farther away but moving in the opposite direction of the first resource, such as for safety considerations, including advanced warning of objects on or off of the roadway or unsafe conditions in the intended path of travel, or detection of objects from different approach angles from the same or different types of sensors. In addition, the resource moving in the opposite direction can contribute additional routing information not yet made available to the first resource. However, there is diminishing value from a safety consideration to the first resource in connecting to resources moving in the opposite direction having already passed the first resource and continuing in the opposite direction, as the sensor information received from such resources may not be aware of new dangers (although there is certain value in received processed data from such resources over that or other portions of the route yet in front of the first resource). Other resources can provide situational awareness and can contribute to a composite risk determination, shifting resource allocation from convenience to safety in dangerous or risky situations. Accordingly, absolute distance between the first resource and the connected source is less of a consideration than a direction and position of the connected source in relation to the direction and position of the first resource.

In certain examples, safety can be prioritized over convenience with a sliding scale towards safety in detected unsafe conditions, such as awareness of a resource that road conditions are wet or slippery, or dangerous lighting conditions (e.g., nighttime driving, traveling towards a setting sun, etc.). Situational awareness can be determined by each resource alone or using information from one or more other sources. A ratio of safety to convenience can be determined for each resource as a function of conditions detected by one or more sensors or using information received from one or more sources. For example, when the first resource is not moving, resources directed to safety can be reduced to utilize more resources on convenience, such as directed to passenger entertainment or processing resources shared with other resources.

Moreover, each determination, such as situational or safety determinations, self-driving inputs, etc., can be determined with a respective confidence. Conclusions or final determinations can be generally broadcast. However, providing conclusions with a determined confidence can be more beneficial. For example, high and low confidence conclusions can be distinguished, providing additional information necessary when making determinations with respect to a specific resource. In certain examples, partial determinations of conditions, such as a probability distribution of potential conditions, can be provided, instead of the determined condition by each resource. In that way, each resource can be the final arbiter of its own situational awareness, additionally reducing liability in providing inaccurate determinations to other resources, allowing each to make composite determinations given specific probability distributions, and not merely conclusions of unknown confidence, reducing the weight and impact of inaccurate or low confidence determinations in their own determinations.

In an example, the curated set of connected sources or conditions for selecting or determining the curated set can be dynamic based on one or more factors or situational changes of the first resource. In certain examples, information of the first resource, such as in-vehicle information (e.g., static mapping information, such as previously downloaded or stored), etc., can be supplemented with broadcast information from connected sources. For example, when leaving a parking garage without connectivity, routing information can be limited, but wait times can be broadcast to update connected cars as to the existing wait times of nearby vehicles, or changes in conditions and relative proximity (e.g., an average wait time of 4 minutes for connected or previously connected vehicles, etc.).

For example, to conserve network communication bandwidth or processing resources, resources can piggyback off routing or traffic information from connected sources to one or more destination points or intermediate destination points. If conditions worsen during routing, such that progress is slower than anticipated when establishing the routing, additional information from connected or nearby sources can be requested, or network communication or processing can be triggered in response, reducing processing power and resources and communication bandwidth if conditions remain stable or improve. Processing resources not used for routing, such as route selection or updates to one or more users, can be used for one or more other purposes, such as offered to connected vehicles, used to improve safety determinations for respective vehicles, etc.

### Number of Data Sources

In certain examples, a size or a number of data sources of an ad hoc network for a first resource can be dynamic and determined based on different considerations, such as described above or herein. The number of data sources generally refers to the number of data sources the first resource is receiving and processing information from or to the number of data sources from which the first resources will respond to requests, etc., and in certain examples can include a specific number or a range of numbers, variable upon different considerations.

Whereas resources can broadcast information generally to any number of resource, such as using a transmitter circuit, the specific data sources from which a resource is connected to, or chooses to receive and process information from, can be limited and in certain examples controlled using information about the specific data source identified by one or more unique identifiers, such as to reduce an amount of processing, data manipulation, or management by the resource.

For example, one consideration can include traffic density. Traffic density is generally an indication of other vehicles surrounding the first resource (e.g., a first vehicle). In certain examples, density can be a function of vehicles seen or detected by one or more sensors of a vehicle, a number of unique identifiers received by one or more communication circuits, one or more received indications of traffic density from one or more other sources (e.g., traffic information, etc.), or combinations thereof. However, in other examples, source density can refer to a number of sources available to provide information to the first resource. Traffic density can be related to, but different than source density, and each can be considered differently for different considerations, such as in determining an indication of situational or safety information, as increased density can require more processing resources in driving control and for safety considerations. Generally, as situational or safety information indicates more dangerous conditions, the number of data sources can increase (with some limit) to receive more information commensurate with the increase in danger to the first resource, balancing power and processing requirements of such increase, as well as power and processing requirements of sensors of the first resource.

### Area (Non-Linear) for Seeking Data Sources

It is possible, however, to be in relatively dense traffic with relatively few sources available from which to receive information. In such situations, it can be necessary to increase a size of the area for seeking data sources. In contrast to the number of data sources, the size of the ad hoc network can refer to a range of communication distance of the ad hoc network from which to send or receive information or to search for data sources.

In certain examples, antennas can be directional (e.g., unidirectional), such that the area for seeking data sources can be shaped or adjusted based on respective combinations of one or more directional antennas associated with respective radio frequency technologies or communication settings (e.g., transmitter or receiver power, gain, sensitivity, etc.). In other examples, antennas can be omnidirectional, such that the area for seeking data sources can be a substantially uniform radius about the antenna, with the radius defining the range, adjusted based on respective radio frequency technologies or communication settings.

Although the range of communication can be omnidirectional, information broadcast from one or more resources within the range can include certain information to enable one or more control circuits or processors to further limit the connected resources by other information associated with the broadcast information, such as position, heading, routing information, or other information, creating an effective non-linear area for potential connected sources.

In an example, an effective non-linear area for potential connected sources can be determined to prioritize safety or convenience, to supplement one or more missing sensor inputs, or to accomplish one or more other objectives. For example, objects on or near a roadway are located, identified, and tracked to provide one or more safety, convenience, or routing inputs. If a resource traveling a planned route ahead of a first resource has recently processed information along the route, such information can be provided to the first resource, reducing the amount of processing required by the first resource, potentially allowing for more detailed or accurate processing information for the benefit of the first resource, or for the benefit of subsequent resources receiving information from the first resource.

In an example, when prioritizing for safety, the effective non-linear area can include an area in the direction of travel of the first resource along a planned route of the first resource, in certain examples, distinguishing lanes of travel and following curves of a road, such as determined based on stored or received routing or mapping information. In certain examples, the effective non-linear area can include an area ahead of the first resource along the planned route of the first resource, although specific to the opposite direction of travel, such as to receive information of objects from one or more opposing sensor viewpoints. Areas close to the first resource, but in front of the first resource, can be prioritized along the same direction of travel. Areas further away from the first resource, but still in front of the first resource, can be prioritized along the opposite direction of travel. In certain examples, the different areas can be further accomplished with successive hops from other connected resources, i.e., resources connected to other resources, etc.

In contrast, when prioritizing for convenience, the effective non-linear areas can prioritize time of connection or available resources of potential connected resources. Similar to above, areas close to the first resource can be prioritized along the same direction of travel. However, in contrast to above, when prioritizing for non-safety considerations, the position of the potential resource as in front of or behind the first resources matters less than the speed, distance, and routing information of the respective resource. In an example, an estimated time of connection can be determined using such information, and potential resources can be prioritized based on the determined estimated time of connection, along with, in certain examples, available resources, etc. For resources in the opposite direction of travel, the priority of the effective non-linear area is the same for convenience as described above for safety.

In certain examples, a combination of convenience and safety can be determined for the first resource as a function of parameters, including situational awareness, speed of travel, etc., such that safety is adequately addressed, providing additional convenience with leftover processing and power resources once safety concerns satisfy or meet a threshold. The threshold can have a minimum safety requirement, with additional safety provided by user settings, such as by a driver or passenger of the first resource, etc.

### Confidence

Each resource (e.g., a vehicle employing any level of autonomous driving) makes determinations, such as using one or more processors or control circuits, with respect to situational or safety inputs or information (e.g., detection or determination of objects on roadways, braking information, road conditions, driving inputs, warnings, etc.), routing information, etc., to a certain degree of confidence, such as using artificial intelligence, machine learning, deep learning, neural networks, etc. Given respective input, such as information from one or more sensors (e.g., cameras, LiDAR, etc.), determinations of different conclusions or decisions, such as a similarly or correlation to one or more training objects, etc., are made with different confidence (e.g., likelihood, given training data, often between 0 and 1, based on a result of one or more weighted inputs or a correlation of different information with one or more models or expected outcomes), and the determination with the highest confidence is often selected as the most likely answer.

Examples of machine learning and neural networks are disclosed in the commonly assigned Luo et al. U.S. application Ser. No. 15/693,142, titled “Cooperative Learning Neural Networks and Systems” and Mondello et al. U.S. Pat. No. 11,328,210, titled “Self-Learning In Distributed Architecture For Enhancing Artificial Neural Network”, each of which are incorporated herein in their entireties, including their descriptions neural network and artificial intelligence systems and object detection using the same.

For example, if a first resource detects an object or data likely indicative of an object off of the roadway, a determination can be made as to the identity of the object, such as using one or more models (e.g., having selected weights or inputs), and a danger associated with the identified object can be determined based on the detected identity and other information about the object, such as its location or movement. If the first resource determines the identity of the object, based on training data or a model, with near certain confidence (e.g., a high confidence) above a threshold (e.g., a likelihood greater than 0.70, 0.90, 0.95, 0.98, 0.99, etc.), the first resource can determine one or more situational or safety inputs or information based on the identified object based on the determined high confidence.

However, if the first resource determines the identity of the object with a low confidence below the threshold, the first resource can request or consider other information from one or more other resources that have also detected the object. The number of sources or the range for seeking potential resources from which to receive and consider information about the detected object can be determined as a function of the degree of confidence determined by the first resource or from a degree of confidence determined by one or more other resources, such as before the first resource arrives at or detects the object.

Similar confidence determinations can be made with respect to object movement, movement of other resources, agreement of sensor information with expected or stored mapping information, identified erratic object or resource movement or behavior, situational awareness, driving or road conditions, etc.

The number or sources or the range for seeking potential sources can vary inversely to the determined confidence, increasing power and processing resources for making specific determinations in response to low confidence determination, and decreasing power and processing resources in response to high confidence determinations. In general, if sensor input is in agreement, such as with respect to the first resource (e.g., between different sensors of the first resource) or between resources, or if information from one or more other resources agree with (e.g., is correlative with or redundant to, etc.) information from the sensors of the first resource, less information from the dynamic ad hoc network can be required to maintain a threshold level of safety of the first resource. If sensor input is not in agreement, such as with respect to the first resource or between resources, or if information from one or more other resources does not agree with information from the sensors of the first resource, more information from the dynamic ad hoc network can be required to provide a threshold level of safety or improve a confidence of one or more determinations of the first resource, improving safety at the cost of additional resources.

In addition, when broadcasting information, determinations with respective confidence can be transmitted, or weights with respect to a particular model that provide an optimal output, instead of only the ultimate determinations, such that borderline determinations by the first resource (e.g., determinations at or near one or more thresholds) are not adversely impacted when combined with corresponding borderline determinations from one or more other resources.

### Share Weights and Not Final Conclusion

Moreover, when broadcasting information, in contrast to broadcasting or providing final determinations and corresponding confidence to one or more other resources, one or more intermediate determinations with respective confidences (or data going into functions to make final determinations, such as data from one or more decision trees, layers, or nodes, calculated or determined weights, etc.) can be provided before or instead of a final determination, increasing the speed at which information is shared and providing more information for other resources to make better and more specific determinations. Intermediate determinations can include, for example, outputs from one or more branches of a decision tree, outputs from one or more hidden or intermediate layers of a neural network, position of k-nearest neighbors with respect to one or more groups before a final determination, outputs of specific decision trees before random forest aggregation, etc. In certain examples, final determinations can be specifically withheld from broadcast or transmission.

For example, if the first resource detects an object off of the roadway and makes several determinations as to the identity of the object, each determination can be provided with their respective confidence, or the top two determinations with their respective confidences can be provided, or determinations and respective confidences above one or more confidence thresholds can be provided, such that other resources can make their own final determinations given additional information from their sensors or information from other sources.

In an example, the first resource can determine that a target object (e.g., at a first location) off of the roadway is likely either a first object (e.g., a garbage can) with a first confidence (e.g., 0.6) or a second object (e.g., a dog) with a second confidence (e.g., 0.4), with both the determined first and second confidence below a threshold. Accordingly, the first resource can supplement sensor information with additional sensor information from one or more other sources having information of the object (e.g., identified based on a determined location, etc.). In an example, the one or more other resources can have information from a different sensor (e.g., a different camera, a different sensor type, etc.), can be closer to or already passed the object, or information from a different angle (e.g., viewing the object from a different direction, etc.), etc. For example, a connected source can determine that the target object is the first object or the second object with the same or different confidences than the first resource. The additional determinations from the connected source can be combined with the determinations from the first resource. If a determined confidence is still not above one or more thresholds, additional information can be requested from one or more additional resources, a number of connected resources can increase, or a range for seeking potential resources can be increased.

In other examples, other information about the target object can be used in making one or more determinations, such as detected movement, predicted locations, etc. Additionally, different objects have different safety considerations. In the example above, the safety considerations for an object that can move on its own (e.g., a dog) are different than an object that typically does not (e.g., a garbage can). Accordingly, the one or more thresholds can vary depending on safety consideration (e.g., pre-defined safety values) of the potential target objects.

Computations can be dynamically shifted between resources, taking other computations into respect while interpreting sensor data of the respective resource. In such a way, identification of potential safe or unsafe conditions can be monitored for a longer period by more sensors than is otherwise capable from a single resource traveling along a route, increasing the probability of safe travel or driving inputs for each connected resource while reducing overall computation resources for each resource to individually interpret its surroundings.

### Warm Tier Memory

To dynamically shift computations between resources, a separate memory tier can be required having attributes of non-volatile memory, including high storage density to transfer dynamic computations, but slower than typical static or main memory (e.g., DRAM), configured to utilize bulk transfer operations commensurate with the speed of data transfer between resources.

Data transfer speeds between connected vehicles can vary depending on the type of radio frequency technology. For example, Bluetooth® 5.0 transfer speeds can approach 2 Mbps, while 4G transfer speed can approach 100 Mbps and 5G transfer speeds can approach 20 Gbps. While DRAM can transfer data at speeds up to or greater than 20 Gbps, NVM is typically slower, denser, and lower cost. Moreover, traditional vehicle bus transfer is slower, under 100 kbps. The fastest NAND NVM memory currently exceeds transfer speeds of 2.4 Gbps, but typical NVM speeds are slower still.

To optimize storage capabilities with cost and data transfer speeds, a storage device can have three (or more) tiers of memory: a first tier (hot tier) of static, main, or volatile memory (e.g., DRAM) to service the memory controller; a second tier (warm tier) of NVM to service the dynamic computations from coupled sources having a higher speed commensurate with the transfer speed of the radio frequency technology used to transfer data in the ad hoc network, slower than the first tier; and a third tier (cold tier) of traditional NVM to store data with a slower speed than the second tier, having more density and a lower cost. Although described with respect to a single storage device having three tiers, in certain examples, the warm tier can be a discrete component, separate from one or more other storage devices.

In an example, a first resource can download or receive data from a resource a certain distance ahead of the first resource, at which point the first resource can supplement the downloaded or received data, reducing processing requirements while supplementing existing data with additional sensed data. Warm tier data can include a header comprising location information for the data along a route including a direction or heading. Data in the warm tier can be used as the starting point to supplement additional data.

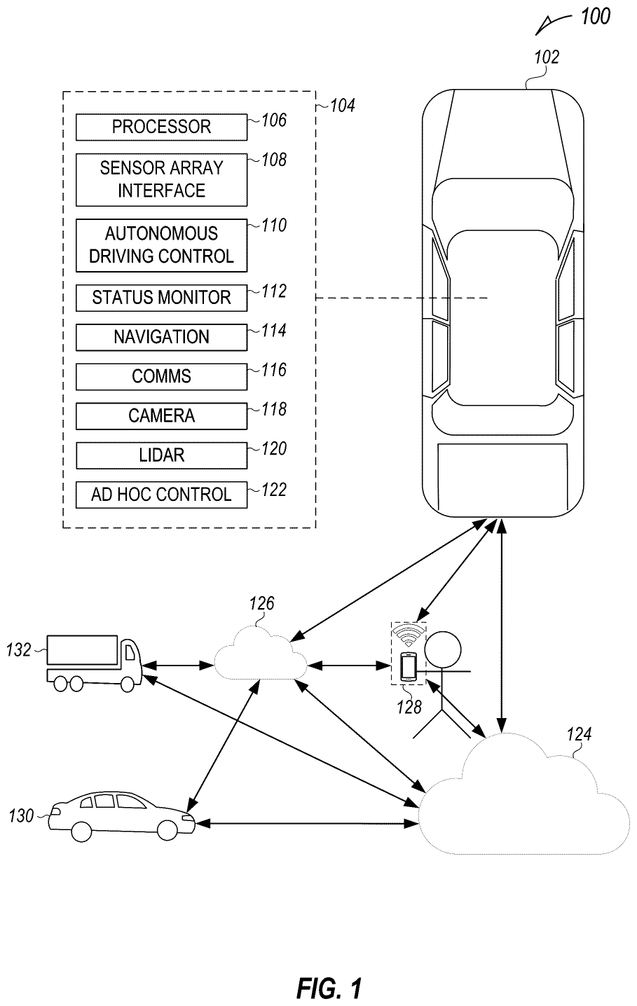

FIG. 1 illustrates an example system 100 to process data to provide improved interactions of a first resource 102 (e.g., an autonomous vehicle) with a surrounding operating environment. The first resource 102 includes a processing platform 104 including a processor system 106 (or other control circuit or host system) and a sensor array interface 108 configured to communicate with one or more sensors (e.g., a camera 118, LiDAR 120, GPS, etc.), etc.

The first resource 102, or a component of the first resource 102, can include any type of commercial, consumer, or recreation vehicle, such as a car, truck, motorcycle, boat, drone, robot, airplane, or any mobile craft able to operate at least partially in an autonomous mode. The first resource 102 can operate in a manual mode where the driver operates the first resource 102 conventionally using pedals, a steering wheel, or other controls. At other times, the first resource 102 can operate in a fully autonomous mode, where the first resource 102 operates without user intervention. In addition, the first resource 102 can operate in a semi-autonomous mode, where the first resource 102 controls many of the aspects of driving, but the driver may intervene or influence the operation using conventional (e.g., steering wheel) and non-conventional inputs (e.g., voice control). In certain examples, the first resource 102 can be considered a MaaS node.

The processor system 106 can include one or more processors, central processing units (CPU), or one or more other processors or processing circuitry and storage or memory to service the same. In an example, the processing platform 104 or the processor system 106 can include or be configured as a vehicle control circuit configured to perform one or more of the operations, techniques, or methods described herein.

The sensor array interface 108 can provide input or output signaling to the processing platform 104 from one or more sensors of the first resource 102. Examples of sensors can include, but are not limited to microphones; forward, side, or rearward facing cameras; radar; LiDAR; ultrasonic distance measurement sensors (e.g., ultrasonic transducers); or other sensors. Forward-facing or front-facing is used in this document to refer to the primary direction of travel, the direction the seats are arranged to face, the direction of travel when the transmission is set to drive, or the like. Conventionally then, rear-facing or rearward-facing can describe sensors that are directed in a roughly opposite direction than those that are forward or front-facing. Side-facing sensors can be directed outward from the sides of the first resource 102.

The first resource 102 can include one or more other sensors, such as driver identification sensors (e.g., a seat sensor, an eye tracking and identification sensor, a fingerprint scanner, a voice recognition module, or the like), occupant sensors, or various environmental sensors to detect wind velocity, outdoor temperature, barometer pressure, rain/moisture, etc. Sensor data can be used in various contexts, such as to determine vehicle operation, environmental information, road conditions, travel conditions, or the like.

The sensor array interface 108 can communicate with other resources to provide or obtain sensor data. Components of the processing platform 104 can communicate with components internal to the processing platform 104 or components that are external to the processing platform 104 using one or more networks, which may include local-area networks (LAN), wide-area networks (WAN), wireless networks (e.g., 802.11 or cellular network), ad hoc networks, personal area networks (e.g., Bluetooth®), vehicle-based networks (e.g., Controller Area Network (CAN) BUS), or other combinations or permutations of network protocols and network types. The one or more networks may include a single local area network (LAN) or wide-area network (WAN), or combinations of LANs or WANs, such as the Internet. The various devices coupled to the network may be coupled to the network via one or more wired or wireless connections.

The processing platform 104 or processor system 106 can include or communicate with a one or more other components, such as an autonomous driving control system 110 (e.g., steering, braking, acceleration, collision avoidance systems, etc.), a status monitor 112 (e.g., tire pressure monitor, oil level sensor, speedometer, safety notifications or warnings, etc.), one or more comfort system (e.g., heat, air conditioning, seat position, etc.), a navigation system 114 (e.g., maps and routing systems, positioning systems, etc.), a communication system 116 (e.g., such as one or more communication circuits including one or more of a receiver, transmitter, transceiver, antenna, or amplifiers, etc.), one or more security systems, one or more sensors (e.g., the camera 118, LiDAR 120, GPS, etc.), etc.

The processing platform 104 can include an ad hoc control circuit 122 configured to control one or more aspects of the communication system 116, such as to connect or control access to one or more of a network 124 (e.g., a cloud network, etc.), an ad hoc network 126, or one or more other wireless data connections. In an example, the ad hoc control circuit 122 can the communication system 116 or aspects of the communication system 116, such as the one or more communication circuits, etc. In addition to the first resource 102, the system 100 includes additional sources or resources including a user device 128, a second resource 130 (e.g., a second vehicle), and a commercial vehicle 132.

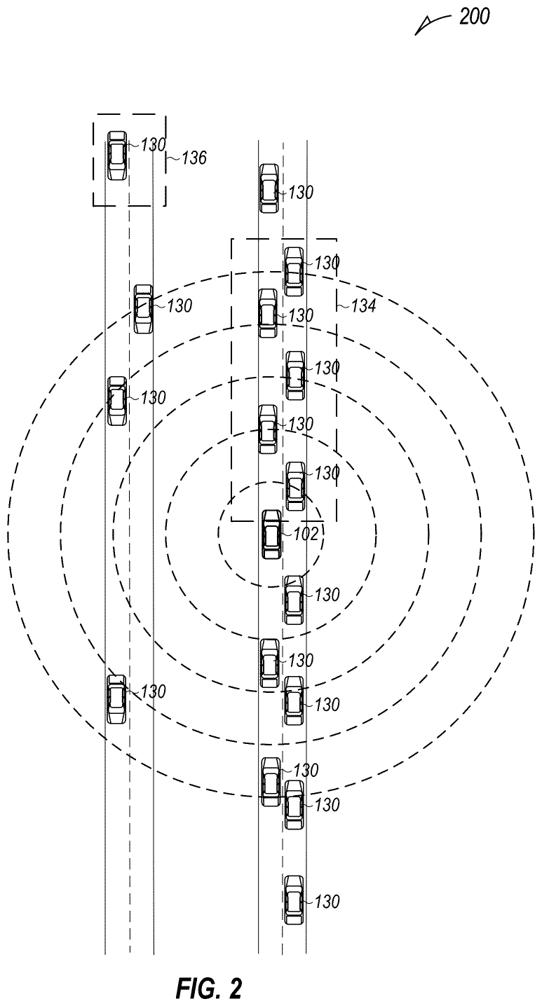

FIG. 2 illustrates an example diagram 200 including a first resource 102 traveling in a first direction along an example roadway (e.g., a divided highway) with a number of potential second resources 130. In certain examples, traffic density can be determined using received traffic information, sensors of the first resource 102 (e.g., camera, LiDAR, radar, ultrasonic, etc.), or potential available connections or unique identifiers of one or more potential second resources 130 detected using one or more components of a communication system (e.g., a transmitter circuit, a receiver circuit, etc.) within a range of the first resource 102.

A desired communication range (e.g., illustrated by dotted circles around the first resource 102, but extending further in certain examples, such as described herein) can be determined as a function of the determined traffic density. In certain examples, as illustrated in FIG. 2, the communication range can be as little as 10 meters or in other examples several miles or greater, depending on communication type, power, or communication settings.

In an example, such as described herein, a non-linear range can be determined for seeking potential connected sources. In certain examples, a ratio of connected sources traveling ahead of but moving in the same direction as the first resource can be preferred over those moving in the same direction as the first resource but behind, or moving in an opposite direction of the first resource. For example, a priority can be extended to resources in a first non-linear area 134 in front of and in the direction of travel of the first resource 102, with an additional preference for potential sources having a speed close to that of the first resource 102, or routing information indicating a shared direction, destination, or intermediate destinations. Such a priority can be expressed as a function of such conditions determined using one or more processors or control circuits of the first resource 102 (e.g., an ad hoc control circuit, etc.). The potential connected sources in the first non-linear area 134 can be scored or ranked according to such factors or one or more other factors, including type of available sensors, etc.

In certain examples, a lesser priority can be extended to one or more other non-linear areas, such as a second non-linear area 136, along the opposite direction of travel of the example roadway, further from the first resource 102, such as to provide a different sensor angle of potential objects, hazards, safety considerations, etc., in front of the first resource 102, etc. In addition, such vehicles can include information about the route ahead of the first resource 102, and the connection time can be sufficient to discover, connect, query, and transmit required information, while providing overlapping view of the physical area in front of the first resource 102 for at least some time.

Whereas area immediately in front of or close to the first resource 102 can be preferred for potential connected resources in the direction of travel of the first resource 102, as illustrated by the first non-linear area 134, area further away from the first resource 102 can be preferred for potential connected resources in the opposite direction of travel of the first resource 102, as illustrated by the second non-linear areas 136.

In an example, the non-linear area for a dynamic ad hoc network can include the first non-linear area 134 and exclude other broadcast areas of the communication system (e.g., the dashed circles in FIG. 2). In other examples, the non-linear area for a dynamic ad hoc network can include the first and second non-overlapping non-linear areas 134, 136 and exclude other broadcast areas of the communication system.

Although illustrated with respect to a divided highway, such is also true with respect to other types of roadways, with a preferred ratio of connected resources in the direction of travel along the route of the first resource 102 (e.g., 5-to-1, 7-to-1, 9-to-1, etc.). The boundaries of the first and second non-linear areas 136, 136 can be determined using mapping data (e.g., stored or received), or a combination of mapping data and sensed data, including one or more of the position of one or more of the potential second resources 130, sensor data from sensors of the first resource 102 or one or more connected sources, and an estimated boundary of the roadway using the mapping, sensor, or position data of the potential second resources 130.

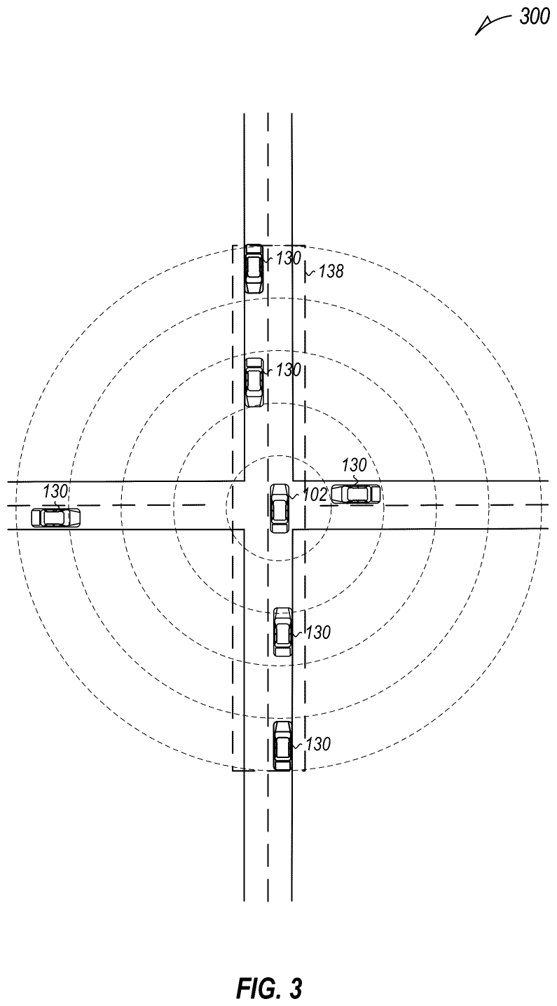

FIG. 3 illustrates an example diagram 300 including a first resource 102 traveling along a roadway (e.g., a two-lane road an intersection) with multiple potential second resources 130 traveling in different directions at different rates of speed. FIG. 3 illustrates an example non-linear area 138, linear along the direction of travel, but non-linear with respect to directions perpendicular to the direction of travel. In certain examples, resources proximate the non-linear area 138 can be distinguished by a rate of travel, such as a difference in speed or absolute speed of the resource in contrast to the first resource 102, or in a heading or direction of travel with the first resource 102. In certain examples, potential second resources 130 can be selected for connection to the first resource 102 (e.g., joining an ad hoc network) based on one or more of a position or location in the non-linear area 138, a heading with or against (and not perpendicular to) the non-linear area 138, a difference in speed of the first resource 102, etc. If a threshold number of connections are not available, the communication range of the first resource 102 can be expanded. In certain examples, the first resource 102 can broadcast information omnidirectionally while only connecting to or considering information from certain ones of the potential second resources 130.

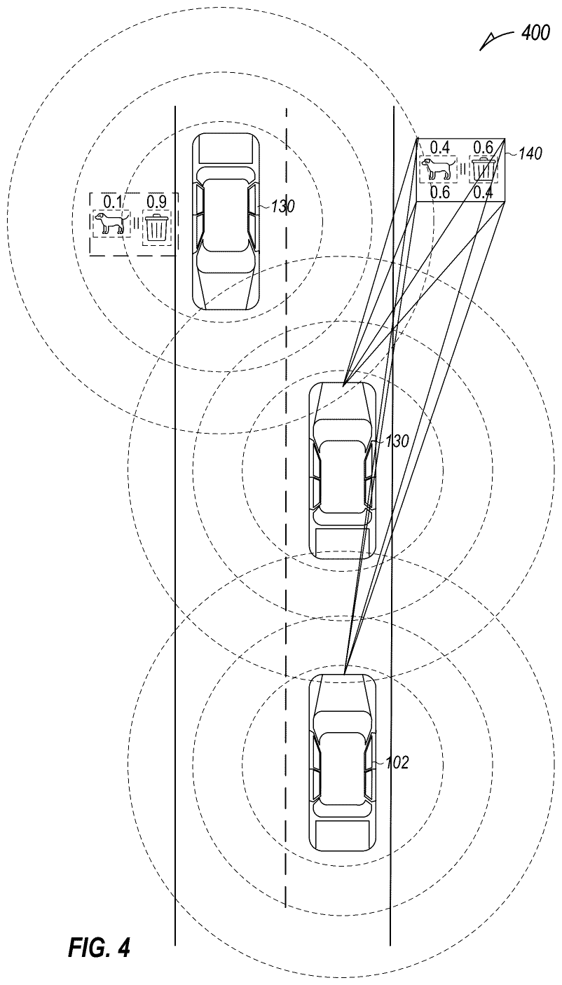

FIG. 4 illustrates an example diagram 400 including a first resource 102 traveling along a roadway (e.g., a two-lane road) with two potential second resources 130, one in front of and moving in the same direction as the first resource 102 and another in front of and moving in an opposite direction as the first resource 102. The direction of travel of the potential second resources 130 can be determined using a combination of position, sensor, or received information from one or more of the potential second resources 130.

In an example, the first resource detects a potential object 140 along the side of the roadway using one or more sensors (e.g., a camera, etc.) and determines the potential object (e.g., using a neural network, etc.) as a dog with confidence of 0.6 or a trash can with a confidence of 0.4. In certain examples, different objects can be assigned different safety values. A mobile object along a roadway, such as a pedestrian or a large animal, etc., is a higher safety concern than a stationary object, such as trash can, etc. If the first resource 102 determines the potential object 140 as having a more dangerous safety value, the speed of the first resource 102 can be reduced, additional processing resources can be allocated to vehicle safety and processing of the potential object 140, or a notification or alert can be provided to the first resource 102 or broadcast to one or more other resources, etc.

However, in this example, the first resource 102 is connected to each of the potential second resources 130, and each of the second potential resources have made separate determinations about the potential object 140 that can supplement the determination of the potential object 140 by the first resource 102, or in other examples can act as a starting point for the determination by the first resource 102. In this example, the connected resource ahead of the first resource 102 in the same direction of travel has determined the potential object 140 as a trash can with a confidence of 0.6 and has assigned a confidence that the potential object 140 is a dog at a confidence of 0.4, but the connected resource in the opposite direction of travel as the first resource 102 with a different viewing angle by its sensors than the resources moving in the opposite direction has determined the potential object 140 as a trash can with a confidence of 0.9 and a dog as 0.1. The first resource 102 can identify the potential object 140 as a combination of the separate determinations, not merely as a function of the conclusions, but as a combination of separate intermediate determinations before the final conclusion, improving the final determination and reducing liability of any one of the resources for providing an incorrect final determination to one or more other resources.

In other examples, the location of the identified potential object 140 can be stored along with sensed information about the potential object 140 from one or more resources and broadcast to one or more other resources having routing information along that roadway or near to the potential object 140, improving safety and determination of the potential object 140 to other resources, providing additional time-based location information for later resources to determine if the potential object 140 moves, possibly indicating a larger potential danger, or remains or disappears.

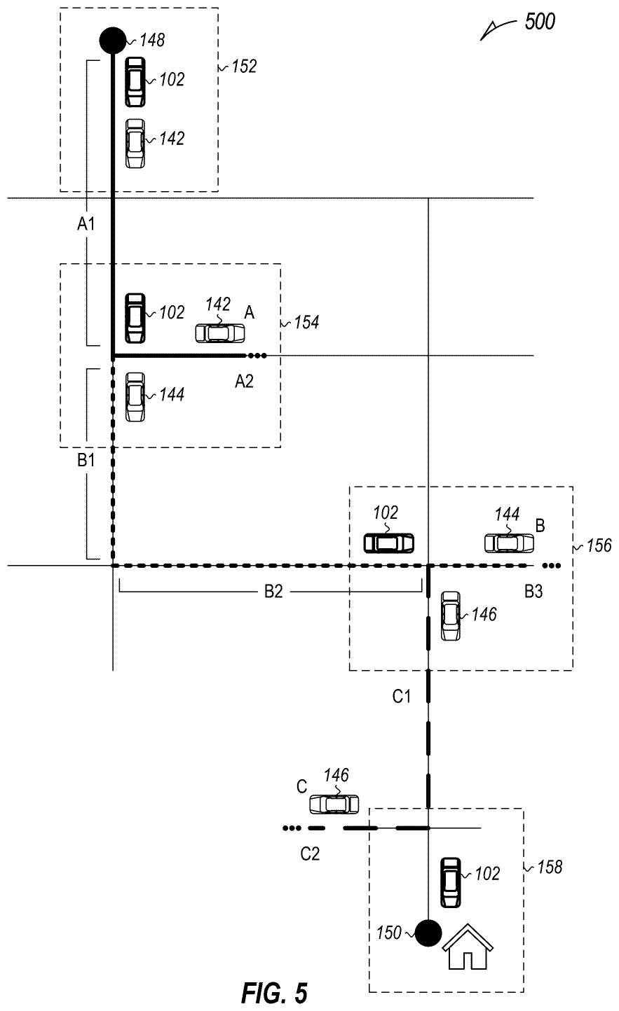

FIG. 5 illustrates an example map 500 illustrating a route for a first resource 102 as separate portions of routes of other resources including second, third, and fourth resources 142, 144, 146 traveling respective routes A, B, and C.

At a first time 152, the first resource 102 begins a route to a destination 150 at an origin 148. The first resource 102 connects to proximate resources, requesting routing information to the destination 150 or one or more intermediate destinations along a route to the destination 150. The second resource 142 has routing information along route A including at least first and second portions A1 and A2. The first resource 102 receives routing information from the second resource 142 to a first intermediate destination along the first portion A1 of route A.

At a second time 154, the second resource 142 follows the second portion A2 of route A, and the first resource 102 connects to the third resource 144 having routing information along route B including at least first, second, and third portions B1, B2, and B3. The first resource 102 receives routing information from the third resource 144 to a second intermediate destination along the second and third portions B1 and B2 of route B.

At a third time 156, the second resource 144 follows the third portion B3 of route B, and the first resource 102 connects to the fourth resource 146 having routing information along route C including at least first and second portions C1 and C2. The first resource 102 receives routing information from the fourth resource 146 to the destination 150 at a fourth time 158 along the first portion C1 of route C.

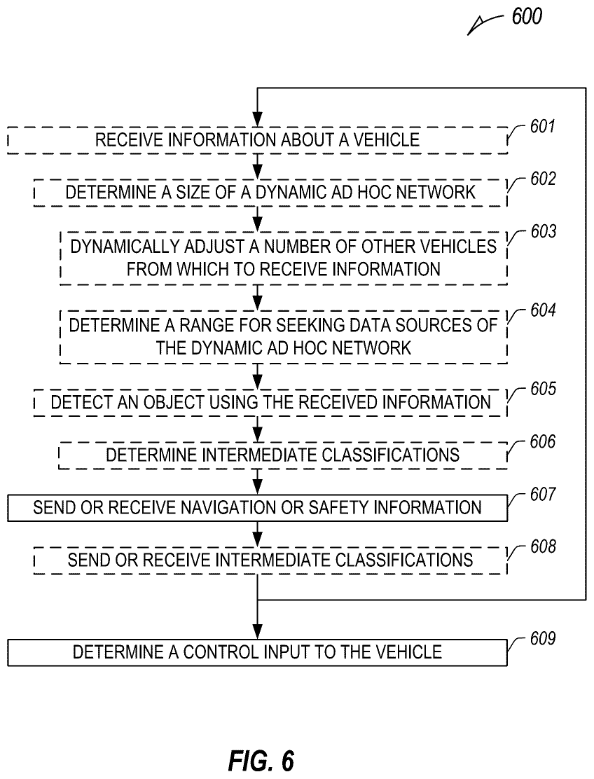

FIG. 6 illustrates an example method 600 for determining a number of data sources or a range for seeking data sources for a dynamic ad hoc network of a vehicle, adjusting a dynamic ad hoc network of a vehicle based on a confidence indication of a detection or determination of a vehicle, or sending or receiving intermediate classifications of an object from one or more machine learning processes or models, for example, instead of a final identification of the object.

At step 601, information can be received about a first resource (e.g., a vehicle), such as using a vehicle control circuit. In certain examples, the information can include information about the first resource, information stored at or available to the first resource, information received from one or more other sources connected to the first resource, or information from one or more sensors of the first resource, etc.

In certain examples, information about the first resource can include information about at least one of a speed of the first resource, a type of roadway of travel of the first resource, an indication of traffic density in an area around the first resource, or other information about the first resource. In other examples, the information about the first resource can include information from one or more sensors of the first resource within the sensor field of view, or information stored by the first resources, such as downloaded or stored mapping information, routing information, position information, etc.

At step 602, a size of a dynamic ad hoc network can be determined, in certain examples, by an ad hoc control circuit, such as using the received information about the first resource, or using information received from one or more other resources (e.g., connected resources of the ad hoc network, etc.). In certain examples, the size of the dynamic ad hoc network can refer to a number of resources from which the first resource receives or processes information from the ad hoc network, a number of resources connected to the ad hoc network, or in other examples a range of the ad hoc network.

At step 603, a number of resources from which the first resource can receive information from can be dynamically adjusted, such as using the ad hoc control circuit, based on one or more conditions or other information about the first resource. For example, incorporating too much outside information can increase processing resources required to manage and utilize the information such that the benefit of the additional information is outweighed by the additional processing costs.

In certain examples, the value of the additional information from the ad hoc network further reduces if the received information agrees with the information of the first resource, or if the received information from multiple resources is in substantial agreement. Accordingly, the dynamic number of resources can be adjusted based on similarity of the received information. If all information is in agreement, the number of sources can be reduced. If information is not in agreement, the number of sources can increase to increase information about the point of disagreement.

In other examples, information from multiple sources can be in agreement, but all have a low determined confidence (e.g., below a threshold, such as 0.7, etc.). If the determined confidence is below a threshold, the number of sources can be increased to receive information to improve the determined confidence, to receive information from one or more different types of sensors or having different views, etc.

In certain examples, the number of resources can include desired ratios of different views, sensors, or directions of travel. For example, sensors located at different heights can provide different views. In certain examples, the viewing angle of a respective sensor can be determined and considered when managing connections to the ad hoc network. In other examples, the type of sensors can be determined (e.g., camera vs. LiDAR, etc.). In other examples, the direction of travel can be determined. In certain examples, a range or ratio of variation can be determined and given priority in the ad hoc network.

At step 604, a range for seeking potential sources or data sources of the dynamic ad hoc network can be determined or dynamically adjusted, such as using the ad hoc control circuit. Similar to that described with respect to steps 602 and 604, the range for seeking potential resources can be adjusted to improve a confidence indication of one or more determinations, or to provide variation in making determinations. For example, the range can be a non-linear range, limited by lanes of travel, sensed or received borders of roadways, etc. A priority for safety can be determined and a non-linear range for seeking potential sources can be established in front of and moving in the same direction of travel as the first resource. In an example, in the opposite direction of travel, a second non-linear area can be defined further away from the first resource but traveling towards. In other examples, the second non-linear is less important because, even though having views overlapping in time, a resource passing the first resource in the opposite direction has stored information about the path the first resource will travel.

At step 605, an object can be detected using the received information about the first resource or using information received from one or more sensors of the first resource or one or more other resources, such as using the vehicle control circuit.

At step 606, one or more intermediate classifications of objects or conditions can be determined, such as using a machine learning model, a neural network having one or more inputs or weights, or one or more other artificial intelligence processes or technologies, based on information about the first resource or using information from one or more other resources, such as using the vehicle control circuit or one or more resources coupled to the vehicle control circuit in the process of detecting or identifying an object or condition.

At step 607, navigation, safety, or other information used to determine one or more control or other inputs (e.g., safety, etc.) for the first or one or more other resources, such as information about one or more detected or identified objects or determined conditions (e.g., situational awareness, safety conditions, etc.), etc., can be sent from the first resource to one or more other resources (e.g., broadcast generally or transmitted to connected resources in an ad hoc network, etc.), or can be received by the first resource from one or more resources of the ad hoc network, etc.

At step 608, the information sent or received in step 607 can include one or more of the intermediate classifications determined in step 606. In an example, the broken line steps illustrated in FIG. 6 are optional. Although the output of step 608 illustrates a feedback loop back to step 601, in other examples, any one or more of the preceding steps can provide feedback to any of the previous steps, or the steps can be rearranged in different combinations or permutations.

At step 609, a control input to the first resource can be determined, such as using a vehicle control circuit or one or more other resources coupled to the vehicle control circuit, and the control input can be provided to or carried out by one or more aspects of the first resource. For example, one or more notifications can be provided, steering input or correction, braking input, reduced speed, a transition of resources from convenience to safety, etc.

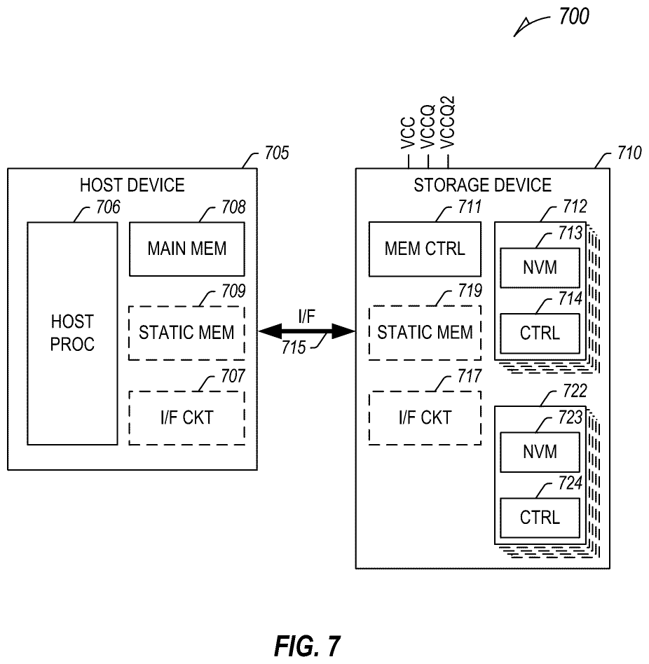

FIG. 7 illustrates an example system 700 (e.g., a host system or processor system) including a host device 705 and a storage device 710 configured to communicate over a communication interface (I/F) 715 (e.g., a bidirectional parallel or serial communication interface). In an example, the communication interface 715 can be referred to as a host interface. The host device 705 can include a host processor 706 (e.g., a host central processing unit (CPU) or other processor or processing circuitry, such as a memory management unit (MMU), interface circuitry, etc.). In certain examples, the host device 705 can include a main memory (MAIN MEM) 708 (e.g., DRAM, etc.) and optionally, a static memory (STATIC MEM) 709, to support operation of the host processor (HOST PROC) 706.

The storage device 710 can include a non-volatile memory device, in certain examples, a single device separate from the host device 705 and components of the host device 705 (e.g., including components illustrated in FIG. 7), in other examples, a component of the host device 705, and in yet other examples, a combination of separate discrete components. For example, the communication interface 715 can include a serial or parallel bidirectional interface, such as defined in one or more Joint Electron Device Engineering Council (JEDEC) standards.

The storage device 710 can include a memory controller (MEM CTRL) 711 and a first non-volatile memory device 712. The memory controller 711 can optionally include a limited amount of static memory 719 (or main memory) to support operations of the memory controller 711. In an example, the first non-volatile memory device 712 can include a number of non-volatile memory devices (e.g., dies or LUNs), such as one or more stacked flash memory devices (e.g., as illustrated with the stacked dashes underneath the first non-volatile memory device 712), etc., each including non-volatile memory (NVM) 713 (e.g., one or more groups of non-volatile memory cells) and a device controller (CTRL) 714 or other periphery circuitry thereon (e.g., device logic, etc.), and controlled by the memory controller 711 over an internal storage-system communication interface (e.g., an Open NAND Flash Interface (ONFI) bus, etc.) separate from the communication interface 715. Control circuitry, as used herein, can refer to one or more of the memory controller 711, the device controller 714, or other periphery circuitry in the storage device 710, the NVM device 712, etc.

Flash memory devices typically include one or more groups of one-transistor, floating gate (FG) or replacement gate (RG) (or charge trapping) storage structures (memory cells). The memory cells of the memory array are typically arranged in a matrix. The gates of each memory cell in a row of the array are coupled to an access line (e.g., a word line). In NOR architecture, the drains of each memory cell in a column of the array are coupled to a data line (e.g., a bit line). In NAND architecture, the drains of each memory cell in a column of the array are coupled together in series, source to drain, between a source line and a bit line.

Each memory cell in a NOR, NAND, 3D XPoint, FeRAM, MRAM, or one or more other architecture semiconductor memory array can be programmed individually or collectively to one or a number of programmed states. A single-level cell (SLC) can represent one bit of data per cell in one of two programmed states (e.g., 1 or 0). A multi-level cell (MLC) can represent two or more bits of data per cell in a number of programmed states (e.g., 2ⁿ, where n is the number of bits of data). In certain examples, MLC can refer to a memory cell that can store two bits of data in one of 4 programmed states. A triple-level cell (TLC) can represent three bits of data per cell in one of 8 programmed states. A quad-level cell (QLC) can represent four bits of data per cell in one of 16 programmed states. In other examples, MLC can refer to any memory cell that can store more than one bit of data per cell, including TLC and QLC, etc.

In three-dimensional (3D) architecture semiconductor memory device technology, memory cells can be stacked, increasing the number of tiers, physical pages, and accordingly, the density of memory cells in a memory device. Data is often stored arbitrarily on the storage system as small units. Even if accessed as a single unit, data can be received in small, random 4-16k single file reads (e.g., 60%-80% of operations are smaller than 16k). It is difficult for a user and even kernel applications to indicate that data should be stored as one sequential cohesive unit. File systems are typically designed to optimize space usage, and not sequential retrieval space.

The memory controller 711, separate from the host processor 706 and the host device 705, can receive instructions from the host device 705, and can communicate with the first non-volatile memory device 712, such as to transfer data to (e.g., write or erase) or from (e.g., read) one or more of the memory cells of the first non-volatile memory device 712. The memory controller 711 can include, among other things, circuitry or firmware, such as a number of components or integrated circuits. For example, the memory controller 711 can include one or more memory control units, circuits, or components configured to control access across the memory array and to provide a translation layer between the host device 705 and the storage system 700, such as a memory manager, one or more memory management tables, etc.

In an example, the storage device 710 can include a second non-volatile memory device 722, separate from the first non-volatile memory device 712, the second non-volatile memory device 722 can include a number of non-volatile memory devices, etc., each including non-volatile memory 723 and a device controller 724 or other periphery circuitry thereon, and controlled by the memory controller 711 over an internal storage-system communication interface separate from the communication interface 715. In an example, the first non-volatile memory device 712 can be configured as a “cold tier” memory device and the second non-volatile memory device 722 can be configured as a “warm tier” memory device (while the main memory 708, the static memory 709, the static memory 719 (or main memory) can be configured as a “hot tier” memory).

The memory manager can include, among other things, circuitry or firmware, such as a number of components or integrated circuits associated with various memory management functions, including, among other functions, wear leveling (e.g., garbage collection or reclamation), error detection or correction, block retirement, or one or more other memory management functions. The memory manager can parse or format host commands (e.g., commands received from the host device 705) into device commands (e.g., commands associated with operation of a memory array, etc.), or generate device commands (e.g., to accomplish various memory management functions) for the device controller 714 or one or more other components of the storage device 710.

The memory manager can include a set of management tables configured to maintain various information associated with one or more component of the storage device 710 (e.g., various information associated with a memory array or one or more memory cells coupled to the memory controller 711). For example, the management tables can include information regarding block age, block erase count, error history, or one or more error counts (e.g., a write operation error count, a read bit error count, a read operation error count, an erase error count, etc.) for one or more blocks of memory cells coupled to the memory controller 711. In certain examples, if the number of detected errors for one or more of the error counts is above a threshold, the bit error can be referred to as an uncorrectable bit error. The management tables can maintain a count of correctable or uncorrectable bit errors, among other things. In an example, the management tables can include translation tables or a L2P mapping.

The memory manager can implement and use data structures to reduce storage device 710 latency in operations that involve searching L2P tables for valid pages, such as garbage collection. To this end, the memory manager is arranged to maintain a data structure (e.g., table region data structure, tracking data structure, etc.) for a physical block. The data structure includes indications of L2P mapping table regions, of the L2P table. In certain examples, the data structure is a bitmap (e.g., a binary array). In an example, the bitmap includes a bit for each region of multiple, mutually exclusive, regions that span the L2P table.

The first non-volatile memory device 712 or the non-volatile memory 713 (e.g., one or more 3D NAND architecture semiconductor memory arrays) can include a number of memory cells arranged in, for example, a number of devices, planes, blocks, physical pages, super blocks, or super pages. As one example, a TLC memory device can include 18,592 bytes (B) of data per page, 1536 pages per block, 548 blocks per plane, and 4 planes per device. As another example, an MLC memory device can include 18,592 bytes (B) of data per page, 1024 pages per block, 548 blocks per plane, and 4 planes per device, but with half the required write time and twice the program/erase (P/E) cycles as a corresponding TLC memory device. Other examples can include other numbers or arrangements. A super block can include a combination of multiple blocks, such as from different planes, etc., and a window can refer to a stripe of a super block, typically matching a portion covered by a physical-to-logical (P2L) table chunk, etc., and a super page can include a combination of multiple pages.

The term “super” can refer to a combination or multiples of a thing or things. For examples, a super block can include a combination of blocks. If a memory device includes 4 planes, a super block may refer to the same block on each plane, or a pattern of blocks across the panes (e.g., a combination of block 0 on plane 0, block 1 on plane 1, block 2 on plane 2, and block 3 on plane 3, etc.). In an example, if a storage system includes multiple memory devices, the combination or pattern of blocks can extend across the multiple memory devices. The term “stripe” can refer to a pattern of combination or pattern of a piece or pieces of a thing or things. For example, a stripe of a super block can refer to a combination or pattern of pages from each block in the super block.

In operation, data is typically written to or read from the storage device 710 in pages and erased in blocks. However, one or more memory operations (e.g., read, write, erase, etc.) can be performed on larger or smaller groups of memory cells, as desired. For example, a partial update of tagged data from an offload unit can be collected during data migration or garbage collection to ensure it was re-written efficiently. The data transfer size of a memory device is typically referred to as a page, whereas the data transfer size of a host device is typically referred to as a sector. Although a page of data can include a number of bytes of user data (e.g., a data payload including a number of sectors of data) and its corresponding metadata, the size of the page often refers only to the number of bytes used to store the user data. As an example, a page of data having a page size of 4 kB may include 4 kB of user data (e.g., 8 sectors assuming a sector size of 512 B) as well as a number of bytes (e.g., 32B, 54B, 224B, etc.) of auxiliary or metadata corresponding to the user data, such as integrity data (e.g., error detecting or correcting code data), address data (e.g., logical address data, etc.), or other metadata associated with the user data.

Different types of memory cells or memory arrays can provide for different page sizes or may require different amounts of metadata associated therewith. For example, different memory device types may have different bit error rates, which can lead to different amounts of metadata necessary to ensure integrity of the page of data (e.g., a memory device with a higher bit error rate may require more bytes of error correction code (ECC) data than a memory device with a lower bit error rate). As an example, an MLC NAND flash device may have a higher bit error rate than a corresponding SLC NAND flash device. As such, the MLC device may require more metadata bytes for error data than the corresponding SLC device.

In an example, the data in a chunk or data unit can be managed in an optimized manner throughout its tenure on the storage system. For example, the data is managed as one unit during data migration (e.g., garbage collection, etc.) such that the efficient read/write properties are preserved as data is moved to its new physical location on the storage system. In certain examples, the only limit to the number of chunks, data units, or blocks configurable for storage, tagging, etc., are the capacities of the system.

One or more of the host device 705 or the storage device 710 can include interface circuitry, such as a host interface circuit (I/F CKT) 707 or a storage interface circuit (I/F CKT) 717, configured to enable communication between components of the host system 700. Each interface circuit can include one or more interconnect layers, such as mobile industry processor interface (MIPI) Unified Protocol (UniPro) and M-PHY layers (e.g., physical layers), including circuit components and interfaces. The M-PHY layer includes the differential transmit (TX) and receive (RX) signaling pairs (e.g., DIN_t, DIN_c and DOUT_t, DOUT_c, etc.). In certain examples, the host interface circuit 707 can include a controller (e.g., a UFS controller), a driver circuit (e.g., a UFS driver), etc. Although described herein with respect to the UniPro and M-PHY layers, one or more other set of circuit components or interfaces can be used to transfer data between circuit components of the host system 700.

Components of the host system 700 can be configured to receive or operate using one or more host voltages, including, for example, VCC, VCCQ, and, optionally, VCCQ2. In certain examples, one or more of the host voltages, or power rails, can be managed or controlled by a power management integrated circuit (PMIC). In certain examples, VCC can be a first supply voltage (e.g., 2.7V-3.3V, 1.7V-1.95V, etc.). In an example, one or more of the static memory 719 or the non-volatile memory devices 712 can require VCC for operation. VCCQ can be a second supply voltage, lower than the VCC (e.g., 1.1V-1.3V, etc.). In an example, one or more of the memory controller 711, the communication interface 715, or memory I/O or other low voltage blocks can optionally require VCCQ for operation. VCCQ2 can be a third supply voltage between VCC and VCCQ (e.g., 1.7V-1.95V, etc.). In an example, one or more of the memory controller 711 of the communication interface, or other low voltage block can optionally require VCCQ2. Each host voltage can be set to provide voltage at one or more current levels, in certain examples, controllable by one or more device descriptors and levels (e.g., between [0:15], each representing a different maximum expected source current, etc.).

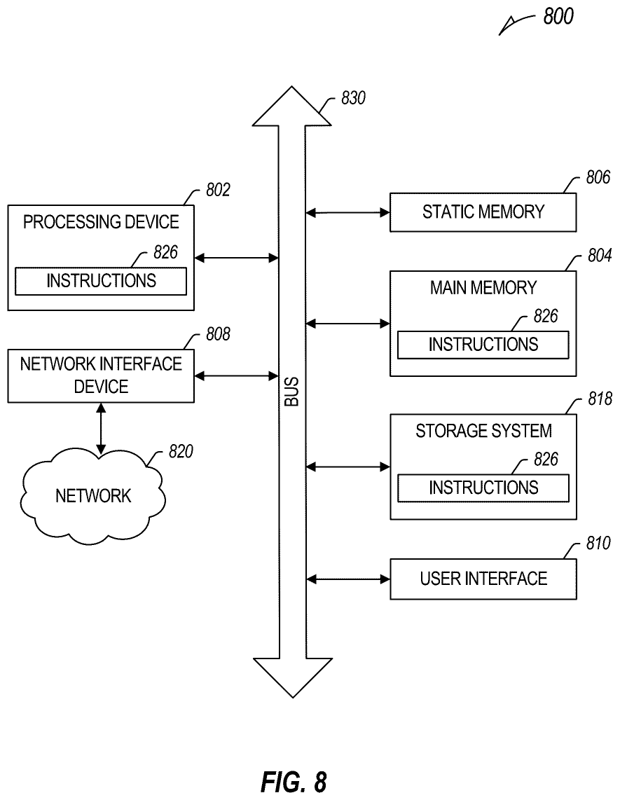

FIG. 8 illustrates a block diagram of an example machine 800 (e.g., a host system) upon which any one or more of the techniques (e.g., methodologies) discussed herein may perform. In alternative embodiments, the machine 800 may operate as a standalone device or may be connected (e.g., networked) to other machines. In a networked deployment, the machine 800 may operate in the capacity of a server machine, a client machine, or both in server-client network environments. In an example, the machine 800 may function as a peer machine in peer-to-peer (P2P) (or other distributed) network environment. The machine 800 may be a personal computer (PC), a tablet PC, a set-top box (STB), a personal digital assistant (PDA), a mobile telephone, a web appliance, an IoT device, automotive system, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate by, logic, components, devices, packages, or mechanisms. Circuitry is a collection (e.g., set) of circuits implemented in tangible entities that include hardware (e.g., simple circuits, gates, logic, etc.). Circuitry membership may be flexible over time and underlying hardware variability. Circuitries include members that may, alone or in combination, perform specific tasks when operating. In an example, hardware of the circuitry may be immutably designed to carry out a specific operation (e.g., hardwired). In an example, the hardware of the circuitry may include variably connected physical components (e.g., execution units, transistors, simple circuits, etc.) including a computer-readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable participating hardware (e.g., the execution units or a loading mechanism) to create members of the circuitry in hardware via the variable connections to carry out portions of the specific tasks when in operation. Accordingly, the computer-readable medium is communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry at a different time.

The machine 800 (e.g., computer system, a host system, etc.) may include a processing device 802 (e.g., a hardware processor, a central processing unit (CPU), a graphics processing unit (GPU), a hardware processor core, or any combination thereof, etc.), a main memory 804 (e.g., read-only memory (ROM), dynamic random-access memory (DRAM), a static memory 806 (e.g., static random-access memory (SRAM), etc.), and a storage system 818, some or all of which may communicate with each other via a communication interface 830 (e.g., a bus).

The processing device 802 can represent one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. The processing device 802 can also be one or more special-purpose processing devices such as an application specific integrated circuit (ASIC), a field programmable gate array (FPGA), a digital signal processor (DSP), network processor, or the like. The processing device 802 can be configured to execute instructions 826 for performing the operations and steps discussed herein. The machine 800 can further include a network interface device 808 to communicate over a network 820.

The storage system 818 can include a machine-readable storage medium (also known as a computer-readable medium) on which is stored one or more sets of instructions 826 or software embodying any one or more of the methodologies or functions described herein. The instructions 826 can also reside, completely or at least partially, within the main memory 804 or within the processing device 802 during execution thereof by the machine 800, the main memory 804 and the processing device 802 also constituting machine-readable storage media.

The term “machine-readable storage medium” should be taken to include a single medium or multiple media that store the one or more sets of instructions, or any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media. In an example, a massed machine-readable medium comprises a machine-readable medium with a plurality of particles having invariant (e.g., rest) mass. Accordingly, massed machine-readable media are not transitory propagating signals. Specific examples of massed machine-readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The machine 800 may further include a user interface 810, such as one or more of a display unit, an alphanumeric input device (e.g., a keyboard), and a user interface (UI) navigation device (e.g., a mouse), etc. In an example, one or more of the display unit, the input device, or the UI navigation device may be a touch screen display. The machine a signal generation device (e.g., a speaker), or one or more sensors, such as a global positioning system (GPS) sensor, compass, accelerometer, or one or more other sensor. The machine 800 may include an output controller, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The instructions 826 (e.g., software, programs, an operating system (OS), etc.) or other data are stored on the storage system 818 can be accessed by the main memory 804 for use by the processing device 802. The main memory 804 (e.g., DRAM) is typically fast, but volatile, and thus a different type of storage than the storage system 818 (e.g., an SSD), which is suitable for long-term storage, including while in an “off” condition. The instructions 826 or data in use by a user or the machine 800 are typically loaded in the main memory 804 for use by the processing device 802. When the main memory 804 is full, virtual space from the storage system 818 can be allocated to supplement the main memory 804; however, because the storage system 818 device is typically slower than the main memory 804, and write speeds are typically at least twice as slow as read speeds, use of virtual memory can greatly reduce user experience due to storage system latency (in contrast to the main memory 804, e.g., DRAM). Further, use of the storage system 818 for virtual memory can greatly reduce the usable lifespan of the storage system 818.

The instructions 824 may further be transmitted or received over a network 820 using a transmission medium via the network interface device 808 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 808 may include one or more physical jacks (e.g., Ethernet, coaxial, or phone jacks) or one or more antennas to connect to the network 820. In an example, the network interface device 808 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 800, and includes digital or analog communications signals or other intangible medium to facilitate communication of such software.

The above detailed description includes references to the accompanying drawings, which form a part of the detailed description. The drawings show, by way of illustration, specific embodiments in which the invention can be practiced. These embodiments are also referred to herein as examples. Such examples can include elements in addition to those shown or described. However, the present inventor also contemplates examples in which only those elements shown or described are provided. Moreover, the present inventor also contemplates examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein”. Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

In various examples, the components, controllers, processors, units, engines, or tables described herein can include, among other things, physical circuitry or firmware stored on a physical device. As used herein, “processor” means any type of computational circuit such as, but not limited to, a microprocessor, a microcontroller, a graphics processor, a digital signal processor (DSP), or any other type of processor or processing circuit, including a group of processors or multi-core devices.

As used herein, directional adjectives, such as horizontal, vertical, normal, parallel, perpendicular, etc., can refer to relative orientations, and are not intended to require strict adherence to specific geometric properties, unless otherwise noted. It will be understood that when an element is referred to as being “on,” “connected to” or “coupled with” another element, it can be directly on, connected, or coupled with the other element or intervening elements may be present. In contrast, when an element is referred to as being “directly on,” “directly connected to” or “directly coupled with” another element, there are no intervening elements or layers present. If two elements are shown in the drawings with a line connecting them, the two elements can be either be coupled, or directly coupled, unless otherwise indicated.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, the code can be tangibly stored on one or more volatile or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.
Embodiments may be implemented in one or a combination of hardware, firmware, and software. Embodiments may also be implemented as instructions stored on a machine-readable storage device, which may be read and executed by at least one processor to perform the operations described herein. A machine-readable storage device may include any non-transitory mechanism for storing information in a form readable by a machine (e.g., a computer). For example, a machine-readable storage device may include read-only memory (ROM), random-access memory (RAM), magnetic disk storage media, optical storage media, flash-memory devices, and other storage devices and media.

A processor subsystem may be used to execute the instruction on the—readable medium. The processor subsystem may include one or more processors, each with one or more cores. Additionally, the processor subsystem may be disposed on one or more physical devices. The processor subsystem may include one or more specialized processors, such as a graphics processing unit (GPU), a digital signal processor (DSP), a field programmable gate array (FPGA), or a fixed function processor.

Examples, as described herein, may include, or may operate on, logic or a number of components, modules, or mechanisms. Modules may be hardware, software, or firmware communicatively coupled to one or more processors in order to carry out the operations described herein. Modules may be hardware modules, and as such modules may be considered tangible entities capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations. Accordingly, the term hardware module is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software; the general-purpose hardware processor may be configured as respective different modules at different times. Software may accordingly configure a hardware processor, for example, to constitute a particular module at one instance of time and to constitute a different module at a different instance of time. Modules may also be software or firmware modules, which operate to perform the methodologies described herein.

As used in any embodiment herein, the term “logic” may refer to firmware or circuitry configured to perform any of the aforementioned operations. Firmware may be embodied as code, instructions or instruction sets, as data hard-coded (e.g., nonvolatile) in memory devices or circuitry, or combinations thereof.

“Circuitry,” as used in any embodiment herein, may comprise, for example, any combination or permutation of hardwired circuitry, programmable circuitry, state machine circuitry, logic, or firmware that stores instructions executed by programmable circuitry. The circuitry may be embodied as an integrated circuit, such as an integrated circuit chip. In some embodiments, the circuitry may be formed, at least in part, by the processor circuitry executing code or instruction sets (e.g., software, firmware, etc.) corresponding to the functionality described herein, thus transforming a general-purpose processor into a specific-purpose processing environment to perform one or more of the operations described herein. In some embodiments, the processor circuitry may be embodied as a stand-alone integrated circuit or may be incorporated as one of several components on an integrated circuit. In some embodiments, the various components and circuitry of the node or other systems may be combined in a system-on-a-chip (SoC) architecture.

In Example 1, subject matter (e.g., a system for determining a number of data sources for a dynamic ad hoc network of a vehicle) includes: a vehicle control circuit configured to determine one or more control inputs to the vehicle; and an ad hoc control circuit configured to: receive information about the vehicle including at least one of a speed of the vehicle, a type of roadway of travel of the vehicle, routing information about the vehicle, or an indication of vehicle density in an area around the vehicle; dynamically adjust a size of the dynamic ad hoc network for the vehicle, the size of the dynamic ad hoc network including a number of other vehicles from which to receive or process information, based on the received information about the vehicle; and receive navigation or safety information from one or more other vehicles in the dynamic ad hoc network, wherein the vehicle control circuit is configured to determine one or more control inputs to the vehicle based at least in part on the received navigation or safety information from one or more other vehicles in the dynamic ad hoc network.

In Example 2, the subject matter of Example 1 optionally includes wherein the size of the dynamic ad hoc network is specific to the number of data sources for the ad hoc control circuit of the vehicle, wherein to dynamically adjust the size of the dynamic ad hoc network based on the received information about the vehicle comprises to dynamically adjust the size of the dynamic ad hoc network as a function of the speed of the vehicle, the type of roadway of travel of the vehicle, and the indication of vehicle density in the area around the vehicle.

In Example 3, the subject matter of Example 2 optionally includes wherein the indication of vehicle density includes at least one of information about a location of the vehicle, a number of vehicles visible to a communication circuit of the vehicle, an indication of traffic density within a threshold distance in a direction of travel along a route of the vehicle, or a number of vehicles detectable by one or more sensors or receivers of the vehicle.

In Example 4, the subject matter of any of Examples 1-3 optionally includes the vehicle control circuit is configured to determine the indication of vehicle density in a communication area or a sensor area around the vehicle, wherein the communication area includes a communication range of a communication circuit of the vehicle and the sensor area includes a detection area of one or more sensors of the vehicle, wherein the communication circuit is a component of the ad hoc control circuit and configured to enable a type of radio frequency communication.

In Example 5, the subject matter of Example 4 optionally includes wherein the ad hoc control circuit is configured to adjust a power of the communication circuit as an inverse function to the indication of vehicle density, wherein the communication area is a function of the power of the communication circuit.

In Example 6, the subject matter of any of Examples 1-5 optionally includes wherein the vehicle control circuit is configured to determine a first indication of vehicle density using information from a communication circuit and a second indication of vehicle density using information from one or more sensors of the vehicle.

In Example 7, the subject matter of Example 6 optionally includes wherein the vehicle control circuit is configured to determine a composite indication of vehicle density as a function of the determined first and second indications.

In Example 8, the subject matter of any of Examples 1-7 optionally includes wherein the vehicle control circuit is configured to determine the indication of vehicle density in a direction of travel of the vehicle based on position and heading information received from the other vehicles in the dynamic ad hoc network.

In Example 9, the subject matter of any of Examples 1-8 optionally includes wherein the vehicle control circuit includes a navigation circuit configured to receive or store mapping information and location information of the vehicle from a global positioning sensor, wherein the received information about the vehicle includes the type of roadway of travel of the vehicle determined using information from the navigation system.

In Example 10, subject matter (e.g., a method for determining a number of data sources for a dynamic ad hoc network of a vehicle) includes: receiving information about the vehicle including at least one of a speed of the vehicle, a type of roadway of travel of the vehicle, routing information about the vehicle, or an indication of vehicle density in an area around the vehicle; dynamically adjusting a size of the dynamic ad hoc network for the vehicle, the size of the dynamic ad hoc network including a number of other vehicles from which to receive or process information, based on the received information about the vehicle; receiving navigation or safety information from one or more other vehicles in the dynamic ad hoc network; and determining one or more control inputs to the vehicle based at least in part on the received navigation or safety information from one or more other vehicles in the dynamic ad hoc network.

In Example 11, the subject matter of Example 10 optionally includes wherein the size of the dynamic ad hoc network is specific to the number of data sources for the dynamic ad hoc network, wherein dynamically adjusting the size of the dynamic ad hoc network based on the received information about the vehicle comprises dynamically adjusting the size of the dynamic ad hoc network as a function of the speed of the vehicle, the type of roadway of travel of the vehicle, and the indication of vehicle density in the area around the vehicle.

In Example 12, the subject matter of Example 11 optionally includes wherein the indication of vehicle density includes at least one of information about a location of the vehicle, a number of vehicles visible to a communication circuit of the vehicle, an indication of traffic density within a threshold distance in a direction of travel along a route of the vehicle, or a number of vehicles detectable by one or more sensors or receivers of the vehicle.

In Example 13, the subject matter of any of Examples 10-12 optionally includes determining the indication of vehicle density in a communication area or a sensor area around the vehicle, wherein the communication area includes a communication range of a communication circuit of the vehicle and the sensor area includes a detection area of one or more sensors of the vehicle, wherein the communication circuit is configured to enable a type of radio frequency communication.

In Example 14, the subject matter of Example 13 optionally includes adjusting a power of the communication circuit as an inverse function to the determined indication of vehicle density, wherein the communication area is a function of the power of the communication circuit.

In Example 15, the subject matter of any of Examples 10-14 optionally includes determining a first indication of vehicle density using information from the dynamic ad hoc network and a second indication of vehicle density using information from one or more sensors of the vehicle; and determining a composite indication of vehicle density as a function of the determined first and second indications, wherein the indication of vehicle density includes the determined composite indication of vehicle density.

In Example 16, the subject matter of any of Examples 10-15 optionally includes determining the indication of vehicle density in a direction of travel of the vehicle based on position and heading information received from the other vehicles in the dynamic ad hoc network.

In Example 17, the subject matter of any of Examples 10-16 optionally includes determining the type of roadway of travel of the vehicle using mapping information and global positioning information from a navigation circuit, wherein receiving information about the vehicle includes receiving the determined type of roadway of travel of the vehicle.

In Example 18, subject matter (e.g., a system for determining a number of data sources for a dynamic ad hoc network of a vehicle) includes: one or more processors; and a memory storing computer-executable instructions that, when executed, cause the one or more processors to control the system to perform operations comprising: receiving information about the vehicle including at least one of a speed of the vehicle, a type of roadway of travel of the vehicle, routing information about the vehicle, or an indication of vehicle density in an area around the vehicle; dynamically adjusting a size of the dynamic ad hoc network for the vehicle, the size of the dynamic ad hoc network including a number of other vehicles from which to receive or process information, based on the received information about the vehicle; receiving navigation or safety information from one or more other vehicles in the dynamic ad hoc network; and determining one or more control inputs to the vehicle based at least in part on the received navigation or safety information from one or more other vehicles in the dynamic ad hoc network.

In Example 19, the subject matter of Example 18 optionally includes wherein the size of the dynamic ad hoc network is specific to the number of data sources for the dynamic ad hoc network, wherein dynamically adjusting the size of the dynamic ad hoc network based on the received information about the vehicle comprises dynamically adjusting the size of the dynamic ad hoc network as a function of the speed of the vehicle, the type of roadway of travel of the vehicle, and the indication of vehicle density in the area around the vehicle, wherein the indication of vehicle density includes at least one of information about a location of the vehicle, a number of vehicles visible to a communication circuit of the vehicle, an indication of traffic density within a threshold distance in a direction of travel along a route of the vehicle, or a number of vehicles detectable by one or more sensors or receivers of the vehicle.

In Example 20, the subject matter of any of Examples 18-19 optionally includes wherein the operations further comprise: determining the indication of vehicle density in a communication area or a sensor area around the vehicle; and adjusting a power of the communication circuit as an inverse function to the determined indication of vehicle density, wherein the communication area is a function of the power of the communication circuit and includes a communication range of a communication circuit of the vehicle and the sensor area includes a detection area of one or more sensors of the vehicle, wherein the communication circuit is configured to enable a type of radio frequency communication.

In Example 21, subject matter (e.g., a system for determining a range for seeking data sources for a dynamic ad hoc network of a vehicle) includes: a vehicle control circuit configured to determine one or more control inputs to the vehicle; and an ad hoc control circuit configured to: receive information about the vehicle including at least one of a speed of the vehicle, a type of roadway of travel of the vehicle, routing information about the vehicle, or an indication of vehicle density in an area around the vehicle; determine a range for seeking data sources of the dynamic ad hoc network for the vehicle based on the received information about the vehicle; and receive navigation or safety information from one or more other vehicles in the dynamic ad hoc network, wherein the vehicle control circuit is configured to determine one or more control inputs to the vehicle based at least in part on the received navigation or safety information from one or more other vehicles in the dynamic ad hoc network.

In Example 22, the subject matter of Example 21 optionally includes wherein to determine the range for seeking data sources of the dynamic ad hoc network for the vehicle, the ad hoc control circuit is configured to dynamically adjust a directional, non-linear area for seeking data sources of the dynamic ad hoc network for the vehicle based on the received information about the vehicle.

In Example 23, the subject matter of Example 22 optionally includes wherein to dynamically adjust the directional, non-linear area for seeking data sources, the ad hoc control circuit is configured to: receive position and heading information of the vehicle, to create the directional, non-linear area for seeking data sources of the dynamic ad hoc network with respect to the position and heading information of the vehicle; receive position and heading information from one or more other potential data sources; and control connection of the one or more other potential data sources to the dynamic ad hoc network based on the received position and heading information from the one or more other potential data sources in the directional, non-linear area for seeking data sources.

In Example 24, the subject matter of any of Examples 22-23 optionally includes wherein the ad hoc control circuit is configured to receive position and heading information of the vehicle, wherein the directional, non-linear area for seeking data sources is with respect to the vehicle, including a first area of a roadway in front of and specific to a direction of travel of the vehicle.

In Example 25, the subject matter of Example 24 optionally includes wherein the directional, non-linear area excludes areas separate from the first area, wherein the first area is a specific portion of and smaller than a broadcast area of a communication circuit of the vehicle.

In Example 26, the subject matter of any of Examples 24-25 optionally includes wherein the directional, non-linear area for seeking data sources includes a second area of roadway in front of and opposite to the direction of travel of the vehicle, wherein the second area is further from the vehicle than the first area and non-overlapping with the first area, wherein the directional, non-linear area excludes areas separate from the first and second areas, wherein the first area and second areas are specific portions of and smaller than a broadcast area of a communication area of the vehicle.

In Example 27, the subject matter of any of Examples 21-26 optionally includes a communication circuit configured to broadcast information to one or more other vehicles and to receive information from the one or more other vehicles in the dynamic ad hoc network, wherein the ad hoc control circuit is configured to control a type of radio frequency communication of the communication circuit and to adjust a power of the communication circuit based on the determined range.

In Example 28, the subject matter of Example 27 optionally includes wherein the communication circuit includes a transmitter circuit, a receiver circuit, and an antenna circuit, wherein to adjust the power of the communication circuit includes to adjust a power of at least one of the receiver circuit or the antenna circuit as a function of the determined range.

In Example 29, the subject matter of any of Examples 27-28 optionally includes wherein the communication circuit is configured to broadcast information to any of the one or more other vehicles in a broadcast range of the communication circuit, wherein the ad hoc control circuit is configured to control connection of one or more other potential data sources to the dynamic ad hoc network based on the determined range, including only receiving and processing information or connecting to one or more potential data sources within the determined range.

In Example 30, subject matter (e.g., a method for determining a range for seeking data sources for a dynamic ad hoc network of a vehicle) includes: receiving information about the vehicle including at least one of a speed of the vehicle, a type of roadway of travel of the vehicle, routing information about the vehicle, or an indication of vehicle density in an area around the vehicle; determining a range for seeking data sources of the dynamic ad hoc network for the vehicle based on the received information about the vehicle; receiving navigation or safety information from one or more other vehicles in the dynamic ad hoc network; and determining one or more control inputs to the vehicle based at least in part on the received navigation or safety information from one or more other vehicles in the dynamic ad hoc network.

In Example 31, the subject matter of Example 30 optionally includes wherein determining the range for seeking data sources of the dynamic ad hoc network for the vehicle comprises dynamically adjusting a directional, non-linear area for seeking data sources of the dynamic ad hoc network for the vehicle based on the received information about the vehicle.

In Example 32, the subject matter of Example 31 optionally includes wherein dynamically adjusting the directional, non-linear area for seeking data sources comprises: receiving position and heading information of the vehicle, to create the directional, non-linear area for seeking data sources of the dynamic ad hoc network with respect to the position and heading information of the vehicle; receiving position and heading information from one or more other potential data sources; and controlling connection of the one or more other potential data sources to the dynamic ad hoc network based on the received position and heading information from the one or more other potential data sources in the directional, non-linear area for seeking data sources.

In Example 33, the subject matter of any of Examples 31-32 optionally includes wherein receiving information about the vehicle comprises receiving position and heading information of the vehicle, wherein the directional, non-linear area for seeking data sources is with respect to the vehicle, including a first area of a roadway in front of and specific to a direction of travel of the vehicle.

In Example 34, the subject matter of Example 33 optionally includes wherein the directional, non-linear area excludes areas separate from the first area, wherein the first area is a specific portion of and smaller than a broadcast area of a communication circuit of the vehicle.

In Example 35, the subject matter of any of Examples 33-34 optionally includes wherein the directional, non-linear area for seeking data sources includes a second area of roadway in front of and opposite to the direction of travel of the vehicle, wherein the second area is further from the vehicle than the first area and non-overlapping with the first area, wherein the directional, non-linear area excludes areas separate from the first and second areas, wherein the first area and second areas are specific portions of and smaller than a broadcast area of a communication area of the vehicle.

In Example 36, the subject matter of any of Examples 30-35 optionally includes broadcasting information to one or more other vehicles and receiving information from the one or more other vehicles in the dynamic ad hoc network using a communication circuit; and controlling a type of radio frequency communication of the communication circuit and adjusting a power of the communication circuit based on the determined range.

In Example 37, the subject matter of Example 36 optionally includes wherein the communication circuit includes a transmitter circuit, a receiver circuit, and an antenna circuit, wherein adjusting the power of the communication circuit includes adjusting a power of at least one of the receiver circuit or the antenna circuit as a function of the determined range.

In Example 38, the subject matter of any of Examples 36-37 optionally includes wherein broadcasting information to one or more other vehicles comprises broadcasting information to any of the one or more other vehicles in a broadcast range of the communication circuit, wherein the method further comprises controlling connection of one or more other potential data sources to the dynamic ad hoc network based on the determined range, including only receiving and processing information or connecting to one or more potential data sources within the determined range.

In Example 39, subject matter (e.g., a system for determining a range for seeking data sources for a dynamic ad hoc network of a vehicle) includes: one or more processors; and a memory storing computer-executable instructions that, when executed, cause the one or more processors to control the system to perform operations comprising: receiving information about the vehicle including at least one of a speed of the vehicle, a type of roadway of travel of the vehicle, routing information about the vehicle, or an indication of vehicle density in an area around the vehicle; determining a range for seeking data sources of the dynamic ad hoc network for the vehicle based on the received information about the vehicle; receiving navigation or safety information from one or more other vehicles in the dynamic ad hoc network; and determining one or more control inputs to the vehicle based at least in part on the received navigation or safety information from one or more other vehicles in the dynamic ad hoc network.

In Example 40, the subject matter of Example 39 optionally includes wherein determining the range for seeking data sources of the dynamic ad hoc network for the vehicle comprises dynamically adjusting a directional, non-linear area for seeking data sources of the dynamic ad hoc network for the vehicle based on the received information about the vehicle, wherein receiving information about the vehicle comprises receiving position and heading information of the vehicle, wherein the directional, non-linear area for seeking data sources is with respect to the vehicle, including a first area of a roadway in front of and specific to a direction of travel of the vehicle, wherein the directional, non-linear area excludes areas separate from the first area, wherein the first area is a specific portion of and smaller than a broadcast area of a communication circuit of the vehicle.

In Example 41, subject matter (e.g., a system for adjusting a dynamic ad hoc network of a vehicle) includes: a vehicle control circuit configured to determine a classification and a confidence indication for the determined classification using information from at least one sensor of the vehicle; an ad hoc control circuit configured to: determine a size of the dynamic ad hoc network for the vehicle, the size of the dynamic ad hoc network including a number of other vehicles from which to receive or process information or a range for seeking potential data sources, based on the determined confidence indication from the vehicle control circuit; and receive navigation or safety information from one or more other vehicles in the dynamic ad hoc network, wherein the vehicle control circuit is configured to determine a control input to the vehicle based at least in part on the received navigation or safety information from one or more other vehicles in the dynamic ad hoc network.

In Example 42, the subject matter of Example 41 optionally includes wherein the ad hoc control circuit is configured to determine the size of the dynamic ad hoc network with respect to the control input as a function of the determined confidence indication, wherein the determined size of the dynamic ad hoc network is inversely proportionate to the determined confidence indication.

In Example 43, the subject matter of any of Examples 41-42 optionally includes wherein the ad hoc control circuit is configured to receive a confidence indication from one or more other vehicles in the dynamic ad hoc network, wherein the ad hoc control circuit is configured to determine the size of the dynamic ad hoc network for the vehicle as a function of the received confidence indication from the one or more other vehicles in the dynamic ad hoc network.

In Example 44, the subject matter of Example 43 optionally includes wherein the ad hoc control circuit is configured to determine the size of the dynamic ad hoc network for the vehicle as a function of a difference between the determined confidence indication from the vehicle control circuit and the received confidence indication from the one or more other vehicles in the dynamic ad hoc network, wherein the determined size of the dynamic ad hoc network is inversely proportionate to the difference.

In Example 45, the subject matter of any of Examples 41-44 optionally includes wherein the ad hoc control circuit is configured to determine the number of other vehicles from which to receive and process information as a function of the determined confidence indication from the vehicle control circuit.

In Example 46, the subject matter of any of Examples 41-45 optionally includes wherein the ad hoc control circuit is configured to determine the range for seeking potential data sources as a function of the determined confidence indication from the vehicle control circuit.

In Example 47, the subject matter of any of Examples 41-46 optionally includes wherein the control input to the vehicle comprises an autonomous driving control input.

In Example 48, the subject matter of any of Examples 41-47 optionally includes wherein the vehicle control circuit is configured to receive separate information about an object from multiple sensors of the vehicle, wherein the determined confidence indication includes a measure of correlation between the received separate information about the object or between separate classifications made using the respective received separate information, wherein the ad hoc control circuit is configured to determine the size of the dynamic ad hoc network for the vehicle as a function of the determined confidence indication from the vehicle control circuit.

In Example 49, subject matter (e.g., a method for adjusting a dynamic ad hoc network of a vehicle) includes: determining a classification and a confidence indication for the determined classification using information from at least one sensor of the vehicle; determining a size of the dynamic ad hoc network for the vehicle, the size of the dynamic ad hoc network including a number of other vehicles from which to receive or process information or a range for seeking potential data sources, based on the determined confidence indication; receiving navigation or safety information from one or more other vehicles in the dynamic ad hoc network; and determining one or more additional control inputs to the vehicle based at least in part on the received navigation or safety information from one or more other vehicles in the dynamic ad hoc network.

In Example 50, the subject matter of Example 49 optionally includes wherein determining the size of the dynamic ad hoc network comprises with respect to the control input as a function of the determined confidence indication, wherein the determined size of the dynamic ad hoc network is inversely proportionate to the determined confidence indication.

In Example 51, the subject matter of any of Examples 49-50 optionally includes receiving a confidence indication from one or more other vehicles in the dynamic ad hoc network, wherein determining the size of the dynamic ad hoc network for the vehicle comprises as a function of the received confidence indication from the one or more other vehicles in the dynamic ad hoc network.

In Example 52, the subject matter of Example 51 optionally includes wherein determining the size of the dynamic ad hoc network for the vehicle comprises as a function of a difference between the determined confidence indication and the received confidence indication from the one or more other vehicles in the dynamic ad hoc network, wherein the determined size of the dynamic ad hoc network is inversely proportionate to the difference.

In Example 53, the subject matter of any of Examples 49-52 optionally includes determining the number of other vehicles from which to receive and process information as a function of the determined confidence indication.

In Example 54, the subject matter of any of Examples 49-53 optionally includes determining the range for seeking potential data sources as a function of the determined confidence indication.

In Example 55, the subject matter of any of Examples 49-54 optionally includes wherein the control input to the vehicle comprises an autonomous driving control input.

In Example 56, the subject matter of any of Examples 49-55 optionally includes receiving separate information about an object from multiple sensors of the vehicle, wherein the determined confidence indication includes a measure of correlation between the received separate information about the object or between separate classifications made using the respective received separate information, wherein determining the size of the dynamic ad hoc network for the vehicle comprises as a function of the determined confidence indication.

In Example 57, subject matter (e.g., a system for adjusting a dynamic ad hoc network of a vehicle) includes: one or more processors; and a memory storing computer-executable instructions that, when executed, cause the one or more processors to control the system to perform operations comprising: determining a classification and a confidence indication for the determined classification using information from at least one sensor of the vehicle; determining a size of the dynamic ad hoc network for the vehicle, the size of the dynamic ad hoc network including a number of other vehicles from which to receive or process information or a range for seeking potential data sources, based on the determined confidence indication; receiving navigation or safety information from one or more other vehicles in the dynamic ad hoc network; and determining one or more additional control inputs to the vehicle based at least in part on the received navigation or safety information from one or more other vehicles in the dynamic ad hoc network.

In Example 58, the subject matter of Example 57 optionally includes wherein determining the size of the dynamic ad hoc network comprises as a function of the determined confidence indication, wherein the determined size of the dynamic ad hoc network is inversely proportionate to the determined confidence indication.

In Example 59, the subject matter of any of Examples 57-58 optionally includes the operations further comprising receiving a confidence indication from one or more other vehicles in the dynamic ad hoc network, wherein determining the size of the dynamic ad hoc network for the vehicle comprises as a function of the received confidence indication from the one or more other vehicles in the dynamic ad hoc network.

In Example 60, the subject matter of Example 59 optionally includes wherein determining the size of the dynamic ad hoc network for the vehicle comprises as a function of a difference between the determined confidence indication and the received confidence indication from the one or more other vehicles in the dynamic ad hoc network, wherein the determined size of the dynamic ad hoc network is inversely proportionate to the difference.

In Example 61, subject matter (e.g., a system) includes: a vehicle control circuit configured to determine, using a machine learning model executed by the vehicle control circuit and information from one or more sensors of the vehicle: one or more intermediate classifications and respective confidence indications for the one or more determined intermediate classifications; and a first identification with a first confidence indication using at least one of the one or more determined intermediate classifications; and an ad hoc control circuit configured to receive one or more intermediate classifications from a dynamic ad hoc network, the dynamic ad hoc network comprising one or more other vehicles, wherein the vehicle control circuit is configured to: determine a composite identification as a function of the one or more received intermediate classifications from the dynamic ad hoc network and at least one of the one or more determined intermediate classifications by the vehicle control circuit or the determined first identification by the vehicle control circuit; and determine one or more control inputs to the vehicle based at least in part on the determined composite identification.

In Example 62, the subject matter of Example 61 optionally includes wherein the one or more determined intermediate classifications include one or more determined intermediate classifications of an object and respective confidence indications for the one or more determined intermediate classifications of the object, wherein the first identification includes a first identification of the object with the first confidence indication using the one or more determined intermediate classifications of the object, wherein the one or more received intermediate classifications from one or more other vehicles in the dynamic ad hoc network include received intermediate classifications of the object from the one or more other vehicles in the dynamic ad hoc network.

In Example 63, the subject matter of Example 62 optionally includes the one or more sensors of the vehicle, the one or more sensors including at least one of a camera, an ultrasonic transducer, a LiDAR sensor, or a radar sensor, wherein the vehicle control circuit is configured to receive the information from the one or more sensors, detect the object in the received information, and to determine the intermediate classifications using information about the detected object from the one or more sensors, wherein the object includes an object within a sensor range of the one or more sensors of the vehicle, including one or more of a line or an indication of a lane of travel of a roadway of the vehicle, one or more other vehicles, an item on or proximate to the roadway, or a traffic sign above or proximate to the roadway.

In Example 64, the subject matter of any of Examples 61-63 optionally includes wherein the ad hoc control circuit configured to receive intermediate classifications and respective confidence indications for the one or more received intermediate classifications from the one or more other vehicles in the dynamic ad hoc network, wherein the vehicle control circuit is configured to determine the composite identification as a function of at least one of the one or more determined intermediate classifications and respective confidence indications by the vehicle control circuit and at least one of the one or more received intermediate classifications and respective confidence indications from the one or other vehicles in the dynamic ad hoc network.

In Example 65, the subject matter of any of Examples 61-64 optionally includes wherein the ad hoc control circuit is configured to determine a size of the dynamic ad hoc network for the vehicle, the size of the dynamic ad hoc network including a number of other vehicles from which to receive or process intermediate classifications or a range for seeking potential data sources, based on at least one of the determined respective confidence indications for the one or more determined intermediate classifications from the vehicle control circuit.

In Example 66, the subject matter of Example 65 optionally includes adjusting the determined size of the ad hoc network based on a difference between at least one of the one or more determined intermediate classifications by the vehicle control circuit and a corresponding at least one of the one or more received intermediate classifications from the one or more other vehicles in the dynamic ad hoc network.

In Example 67, the subject matter of any of Examples 65-66 optionally includes connecting to the one or more other vehicles in the dynamic ad hoc network using a communication circuit and transmitting at least one of the one or more determined intermediate classifications to one or more other vehicles in the dynamic ad hoc network using the communication circuit.

In Example 68, the subject matter of any of Examples 65-67 optionally includes withholding transmitting the determined first identification to the one or more other vehicles in the dynamic ad hoc network.

In Example 69, the subject matter of any of Examples 65-68 optionally includes broadcasting vehicle information separate from the determined intermediate classifications to one or more other vehicles in a broadcast range of the communication circuit, the broadcast range depending at least in part on a power of the communication circuit or a type of radio frequency communication of the communication circuit.

In Example 70, subject matter (e.g., a method) includes: determining, using a machine learning model executed by a vehicle control circuit and information from one or more sensors of the vehicle, one or more intermediate classifications and respective confidence indications for the one or more determined intermediate classifications; determining a first identification with a first confidence indication using at least one of the one or more determined intermediate classifications; receiving one or more intermediate classifications from a dynamic ad hoc network, the dynamic ad hoc network comprising one or more other vehicles; determining a composite identification as a function of the one or more received intermediate classifications from the dynamic ad hoc network and at least one of the one or more determined intermediate classifications by the vehicle control circuit or the determined first identification by the vehicle control circuit; and determining one or more control inputs to the vehicle based at least in part on the determined composite identification.

In Example 71, the subject matter of Example 70 optionally includes wherein determining the one or more intermediate classifications include determining one or more intermediate classifications of an object and respective confidence indications for the one or more determined intermediate classifications of the object, wherein determining the first identification includes determining a first identification of the object with the first confidence indication using at least one of the one or more determined intermediate classifications of the object, wherein receiving one or more intermediate classifications from the dynamic ad hoc network includes receiving one or more intermediate classifications of the object from the one or more other vehicles in the dynamic ad hoc network.

In Example 72, the subject matter of Example 71 optionally includes receiving information from the one or more sensors of the vehicle, the one or more sensors of the vehicle including at least one of a camera, an ultrasonic transducer, a LiDAR sensor, or a radar sensor, wherein determining the first identification of the object includes detecting the object in the received information, wherein the object includes an object within a sensor range of the one or more sensors of the vehicle, including one or more of a line or an indication of a lane of travel of a roadway of the vehicle, one or more other vehicles, an item on or proximate to the roadway, or a traffic sign above or proximate to the roadway.

In Example 73, the subject matter of any of Examples 70-72 optionally includes wherein receiving one or more intermediate classifications and respective confidence indications for the one or more received intermediate classifications from the dynamic ad hoc network comprises receiving one or more intermediate classifications and respective confidence indications for the one or more received intermediate classifications from the one or more other vehicles in the dynamic ad hoc network, wherein determining the composite identification comprises as a function of at least one of the determined intermediate classifications and respective confidence indications by the vehicle control circuit and at least one of the one or more received intermediate classifications and respective confidence indications from the one or other vehicles in the dynamic ad hoc network.

In Example 74, the subject matter of any of Examples 70-73 optionally includes determining a size of the dynamic ad hoc network for the vehicle, the size of the dynamic ad hoc network including a number of other vehicles from which to receive or process intermediate classifications or a range for seeking potential data sources, based on at least one of the one or more determined respective confidence indications for the one or more determined intermediate classifications.

In Example 75, the subject matter of Example 74 optionally includes wherein the ad hoc control circuit is configured to adjust the determined size of the ad hoc network based on a difference between at least one of the one or more determined intermediate classifications by the vehicle control circuit and a corresponding at least one of the one or more received intermediate classifications from the one or more other vehicles in the dynamic ad hoc network.

In Example 76, the subject matter of any of Examples 74-75 optionally includes a communication circuit configured to connect to the one or more other vehicles in the dynamic ad hoc network, wherein the communication circuit is configured to: transmit the determined intermediate classifications to the one or more other vehicles in the dynamic ad hoc network; and receive the intermediate classifications from the one or more other vehicles in the dynamic ad hoc network.

In Example 77, the subject matter of Example 76 optionally includes wherein the communication circuit is configured to withhold transmitting the determined first identification to the one or more other vehicles in the dynamic ad hoc network.

In Example 78, the subject matter of any of Examples 76-77 optionally includes wherein the communication circuit is configured to broadcast vehicle information separate from the determined intermediate classifications to one or more other vehicles in a broadcast range of the communication circuit, the broadcast range depending at least in part on a power of the communication circuit or a type of radio frequency communication of the communication circuit.

In Example 79, subject matter (e.g., a system) includes: one or more processors; and a memory storing computer-executable instructions that, when executed, cause the one or more processors to control the system to perform operations comprising: determining, using a machine learning model executed by a vehicle control circuit and information from one or more sensors of the vehicle intermediate classifications and respective confidence indications of the determined intermediate classifications; determining a first identification with a first confidence indication using the determined intermediate classifications; receiving one or more intermediate classifications from a dynamic ad hoc network, the dynamic ad hoc network comprising one or more other vehicles; determining a composite identification as a function of at least one of the one or more received intermediate classifications from the dynamic ad hoc network and at least one of the one or more determined intermediate classifications by the vehicle control circuit or the determined first identification by the vehicle control circuit; and determining one or more control inputs to the vehicle based at least in part on the determined composite identification.

In Example 80, the subject matter of Example 79 optionally includes wherein receiving one or more intermediate classifications and respective confidence indications for the one or more received intermediate classifications from the dynamic ad hoc network comprises receiving one or more intermediate classifications and respective confidence indications for the one or more received intermediate classifications from the one or more other vehicles in the dynamic ad hoc network, wherein determining the composite identification comprises as a function of at least one of the determined intermediate classifications and respective confidence indications by the vehicle control circuit and at least one of the one or more received intermediate classifications and respective confidence indications from the one or other vehicles in the dynamic ad hoc network.

In Example 81, subject matter (e.g., a system or apparatus) may optionally combine any portion or combination of any portion of any one or more of Examples 1-80 to comprise “means for” performing any portion of any one or more of the functions or methods of Examples 1-80, or at least one “non-transitory machine-readable medium” including instructions that, when performed by a machine, cause the machine to perform any portion of any one or more of the functions or methods of Examples 1-80.

The above detailed description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment, and it is contemplated that such embodiments can be combined with each other in various combinations or permutations. The scope of the disclosure should, therefore, be determined with references to the appended claims, along with the full scope of equivalents to which such claims are entitled.

What is claimed is:

1. A system for determining a range for seeking data sources for a dynamic ad hoc network of a vehicle, comprising:
a vehicle control circuit configured to determine one or more control inputs to the vehicle; and
an ad hoc control circuit configured to:
receive information about the vehicle including at least one of a speed of the vehicle, a type of roadway of travel of the vehicle, routing information about the vehicle, or an indication of vehicle density in an area around the vehicle;
determine a range for seeking data sources of the dynamic ad hoc network for the vehicle based on the received information about the vehicle; and
receive navigation or safety information from one or more other vehicles in the dynamic ad hoc network,
wherein the vehicle control circuit is configured to determine one or more control inputs to the vehicle based at least in part on the received navigation or safety information from one or more other vehicles in the dynamic ad hoc network.

2. The system of claim 1, wherein to determine the range for seeking data sources of the dynamic ad hoc network for the vehicle, the ad hoc control circuit is configured to dynamically adjust a directional, non-linear area for seeking data sources of the dynamic ad hoc network for the vehicle based on the received information about the vehicle.

3. The system of claim 2, wherein to dynamically adjust the directional, non-linear area for seeking data sources, the ad hoc control circuit is configured to:
receive position and heading information of the vehicle, to create the directional, non-linear area for seeking data sources of the dynamic ad hoc network with respect to the position and heading information of the vehicle;
receive position and heading information from one or more other potential data sources; and
control connection of the one or more other potential data sources to the dynamic ad hoc network based on the received position and heading information from the one or more other potential data sources in the directional, non-linear area for seeking data sources.

4. The system of claim 2, wherein the ad hoc control circuit is configured to receive position and heading information of the vehicle,
wherein the directional, non-linear area for seeking data sources is with respect to the vehicle, including a first area of a roadway in front of and specific to a direction of travel of the vehicle.

5. The system of claim 4, wherein the directional, non-linear area excludes areas separate from the first area,
wherein the first area is a specific portion of and smaller than a broadcast area of a communication circuit of the vehicle.

6. The system of claim 4, wherein the directional, non-linear area for seeking data sources includes a second area of roadway in front of and opposite to the direction of travel of the vehicle,
wherein the second area is further from the vehicle than the first area and non-overlapping with the first area,
wherein the directional, non-linear area excludes areas separate from the first and second areas,
wherein the first area and second areas are specific portions of and smaller than a broadcast area of a communication area of the vehicle.

7. The system of claim 1, comprising a communication circuit configured to broadcast information to one or more other vehicles and to receive information from the one or more other vehicles in the dynamic ad hoc network,
wherein the ad hoc control circuit is configured to control a type of radio frequency communication of the communication circuit and to adjust a power of the communication circuit based on the determined range.

8. The system of claim 7, wherein the communication circuit includes a transmitter circuit, a receiver circuit, and an antenna circuit,
wherein to adjust the power of the communication circuit includes to adjust a power of at least one of the receiver circuit or the antenna circuit as a function of the determined range.

9. The system of claim 7, wherein the communication circuit is configured to broadcast information to any of the one or more other vehicles in a broadcast range of the communication circuit,
wherein the ad hoc control circuit is configured to control connection of one or more other potential data sources to the dynamic ad hoc network based on the determined range, including only receiving and processing information or connecting to one or more potential data sources within the determined range.

10. A method for determining a range for seeking data sources for a dynamic ad hoc network of a vehicle, comprising:
receiving information about the vehicle including at least one of a speed of the vehicle, a type of roadway of travel of the vehicle, routing information about the vehicle, or an indication of vehicle density in an area around the vehicle;
determining a range for seeking data sources of the dynamic ad hoc network for the vehicle based on the received information about the vehicle;
receiving navigation or safety information from one or more other vehicles in the dynamic ad hoc network; and
determining one or more control inputs to the vehicle based at least in part on the received navigation or safety information from one or more other vehicles in the dynamic ad hoc network.

11. The method of claim 10, wherein determining the range for seeking data sources of the dynamic ad hoc network for the vehicle comprises dynamically adjusting a directional, non-linear area for seeking data sources of the dynamic ad hoc network for the vehicle based on the received information about the vehicle.

12. The method of claim 11, wherein dynamically adjusting the directional, non-linear area for seeking data sources comprises:
receiving position and heading information of the vehicle, to create the directional, non-linear area for seeking data sources of the dynamic ad hoc network with respect to the position and heading information of the vehicle;
receiving position and heading information from one or more other potential data sources; and
controlling connection of the one or more other potential data sources to the dynamic ad hoc network based on the received position and heading information from the one or more other potential data sources in the directional, non-linear area for seeking data sources.

13. The method of claim 11, wherein receiving information about the vehicle comprises receiving position and heading information of the vehicle,
wherein the directional, non-linear area for seeking data sources is with respect to the vehicle, including a first area of a roadway in front of and specific to a direction of travel of the vehicle.

14. The method of claim 13, wherein the directional, non-linear area excludes areas separate from the first area,
wherein the first area is a specific portion of and smaller than a broadcast area of a communication circuit of the vehicle.

15. The method of claim 13, wherein the directional, non-linear area for seeking data sources includes a second area of roadway in front of and opposite to the direction of travel of the vehicle,
wherein the second area is further from the vehicle than the first area and non-overlapping with the first area,
wherein the directional, non-linear area excludes areas separate from the first and second areas,
wherein the first area and second areas are specific portions of and smaller than a broadcast area of a communication area of the vehicle.

16. The method of claim 10, comprising:
broadcasting information to one or more other vehicles and receiving information from the one or more other vehicles in the dynamic ad hoc network using a communication circuit; and
controlling a type of radio frequency communication of the communication circuit and adjusting a power of the communication circuit based on the determined range.

17. The method of claim 16, wherein the communication circuit includes a transmitter circuit, a receiver circuit, and an antenna circuit,
wherein adjusting the power of the communication circuit includes adjusting a power of at least one of the receiver circuit or the antenna circuit as a function of the determined range.

18. The method of claim 16, wherein broadcasting information to one or more other vehicles comprises broadcasting information to any of the one or more other vehicles in a broadcast range of the communication circuit,
wherein the method further comprises controlling connection of one or more other potential data sources to the dynamic ad hoc network based on the determined range, including only receiving and processing information or connecting to one or more potential data sources within the determined range.

19. A system for determining a range for seeking data sources for a dynamic ad hoc network of a vehicle, comprising:
hoc one or more processors; and
a memory storing computer-executable instructions that, when executed, cause the one or more processors to control the system to perform operations comprising:
receiving information about the vehicle including at least one of a speed of the vehicle, a type of roadway of travel of the vehicle, routing information about the vehicle, or an indication of vehicle density in an area around the vehicle;
determining a range for seeking data sources of the dynamic ad hoc network for the vehicle based on the received information about the vehicle;
receiving navigation or safety information from one or more other vehicles in the dynamic ad hoc network; and
determining one or more control inputs to the vehicle based at least in part on the received navigation or safety information from one or more other vehicles in the dynamic ad hoc network.

20. The system of claim 19, wherein determining the range for seeking data sources of the dynamic ad hoc network for the vehicle comprises dynamically adjusting a directional, non-linear area for seeking data sources of the dynamic ad hoc network for the vehicle based on the received information about the vehicle, wherein receiving information about the vehicle comprises receiving position and heading information of the vehicle,
wherein the directional, non-linear area for seeking data sources is with respect to the vehicle, including a first area of a roadway in front of and specific to a direction of travel of the vehicle,
wherein the directional, non-linear area excludes areas separate from the first area,
wherein the first area is a specific portion of and smaller than a broadcast area of a communication circuit of the vehicle.
